(19) United States
(12) Patent Application Publication
(10) Pub. No.: US 2025/0071477 A1
(43) Pub. Date: Feb. 27, 2025

(54) ACOUSTIC PLAYBACK WAVEGUIDE FOR WEARABLE XR GLASSES

(71) Applicant: MAGIC LEAP, INC., Plantation, FL (US)

(72) Inventors: Jean-Marc JOT, Aptos, CA (US); Remi Samuel AUDFRAY, San Francisco, CA (US); Richard D. HERR, Wilton Manors, FL (US); Mark BLANCHARD, Margate, FL (US)

(21) Appl. No.: 18/703,308

(22) PCT Filed: Oct. 26, 2022
(86) PCT No.: PCT/US2022/078727

§ 371 Date: Apr. 19, 2024

Related U.S. Application Data
(60) Provisional application No. 63/272,561, filed on Oct. 27, 2021.

(51) Int. Cl. H04R 1/34; G02B 27/01; H04R 1/28; H04R 1/40; H04R 3/12

(52) U.S. Cl. CPC H04R 1/345; G02B 27/0172; H04R 1/2857; H04R 1/288; H04R 1/403; H04R 3/12; G02B 2027/0178; H04R 2430/20; H04R 2499/15

(57) ABSTRACT

Embodiments of the present disclosure are directed to an acoustic waveguide for presenting an audio signal. An apparatus in accordance with embodiments of this disclosure can include a waveguide member comprising a hollow body having a first end and a second end. The apparatus can further include a sound source disposed at the first end of the waveguide configured to emit at least a first sound wave. The apparatus can further include a plurality of acoustic vents disposed on a lower surface of the body of the waveguide, wherein each of the plurality of acoustic vents is configured to receive the first sound wave and further configured to emit a respective sound wave based on the first sound wave, wherein each respective sound wave corresponds to a respective point sound source.

### CROSS REFERENCE TO RELATED APPLICATION

This application claims priority to U.S. Provisional Application No. 63/272,561, filed on Oct. 27, 2021, the contents of which are incorporated by reference herein in their entirety.

### FIELD

This disclosure relates in general to systems for presenting one or more audio signals, and in particular to head mounted devices for presenting one or more audio signals to a user.

### BACKGROUND

Virtual environments are ubiquitous in computing environments, finding use in video games (in which a virtual environment may represent a game world); maps (in which a virtual environment may represent terrain to be navigated); simulations (in which a virtual environment may simulate a real environment); digital storytelling (in which virtual characters may interact with each other in a virtual environment); and many other applications. Modern computer users are generally comfortable perceiving, and interacting with, virtual environments. However, users' experiences with virtual environments can be limited by the technology for presenting virtual environments. For example, conventional displays (e.g., 2D display screens) and audio systems (e.g., fixed speakers) may be unable to realize a virtual environment in ways that create a compelling, realistic, and immersive experience.

Virtual reality (“VR”), augmented reality (“AR”), mixed reality (“MR”), and related technologies (collectively, “XR”) share an ability to present, to a user of a XR system, sensory information corresponding to a virtual environment represented by data in a computer system. Such systems can offer a uniquely heightened sense of immersion and realism by combining virtual visual and audio cues with real sights and sounds. Accordingly, it can be desirable to present digital sounds to a user of a XR system in such a way that the sounds seem to be occurring-naturally, and consistently with the user's expectations of the sound—in the user's real environment. Generally speaking, users expect that virtual sounds will take on the acoustic properties of the real environment in which they are heard. For instance, a user of a XR system in a large concert hall will expect the virtual sounds of the XR system to have large, cavernous sonic qualities; conversely, a user in a small apartment will expect the sounds to be more dampened, close, and immediate. In addition to matching virtual sounds with acoustic properties of a real and/or virtual environment, realism is further enhanced by spatializing virtual sounds. For example, a virtual object may visually fly past a user from behind, and the user may expect the corresponding virtual sound to similarly reflect the spatial movement of the virtual object with respect to the user.

Existing technologies often fall short of these expectations, such as by presenting virtual audio that does not take into account a user's surroundings or does not correspond to spatial movements of a virtual object, leading to feelings of inauthenticity that can compromise the user experience. Observations of users of XR systems indicate that while users may be relatively forgiving of visual mismatches between virtual content and a real environment (e.g., inconsistencies in lighting); users may be more sensitive to auditory mismatches. Our own auditory experiences, refined continuously throughout our lives, can make us acutely aware of how our physical environments affect the sounds we hear; and we can be hyper-aware of sounds that are inconsistent with those expectations. With XR systems, such inconsistencies can be jarring, and can turn an immersive and compelling experience into a gimmicky, imitative one. In extreme examples, auditory inconsistencies can cause motion sickness and other ill effects, as the inner ear is unable to reconcile auditory stimuli with their corresponding visual cues.

Rendering virtual sound objects in the user's field of view with an XR system can be challenging, particularly when the sound is delivered to the user with traditional earbuds and/or speakers mounted close to the entrance of the user's ear canal. In a real world environment, sound is generally received by an individual's ear via a frontal incidence wavefront. The frontal incidence wavefront can interact with an individual's pinna, i.e., the fleshy visible outer part of the ear, which can impart a unique acoustic signature to external sounds heard by the individual. When a speaker is mounted over-ear or in-ear, the sound received by the user may not include this unique acoustic signature, which can detract from a user's immersive XR experience. Moreover, placing the audio transducer of the speaker near a user's ear can add bulk and weight to the arms of the head mounted display, which can be uncomfortable when a user's ear supports that weight. Additionally, some speaker systems may be prone to sound leakage, such that other individuals in the vicinity can hear the sound produced by the speakers. Sound leakage may not only be annoying for the user and other individuals, but can also interfere with a user's audio privacy. Thus, it can be desirable to provide a speaker system that can provide sound incidence that will include a user's pinna acoustic signature with minimal sound leakage.

### BRIEF SUMMARY

Embodiments of the present disclosure are directed to an acoustic waveguide for presenting an audio signal and a method of use. Acoustic waveguides in accordance with embodiments of the present disclosure can provide a frontal sound incidence to a user such that the sound perceived by a user may include the acoustic signature of the user's pinna. Embodiments of the present disclosure may also provide minimal sound leakage due to the sound source directivity of the acoustic waveguide. An apparatus in accordance with embodiments of this disclosure can include a waveguide member comprising a hollow body having a first end and a second end. The apparatus can further include a sound source disposed at the first end of the waveguide configured to emit at least a first sound wave. The apparatus can further include a plurality of acoustic vents disposed on a lower surface of the body of the waveguide, wherein each of the plurality of acoustic vents is configured to receive the first sound wave and further configured to emit a respective sound wave based on the first sound wave, wherein each respective sound wave corresponds to a respective point sound source.

Embodiments of the present disclosure can include a head wearable device. For example, the head wearable device can include a front frame, a display coupled to the front frame, an arm coupled to the front frame and configured to attach the head wearable device to a user's head, and an acoustic waveguide. In one or more examples, the acoustic waveguide can include a waveguide member comprising a hollow body having a first end and a second end, a sound source disposed at the first end of the waveguide, and a plurality of acoustic vents disposed on a lower surface of the body of the waveguide, wherein each of the plurality of acoustic vents is configured to receive the first sound wave and further to emit a respective sound wave based on the first sound wave, wherein each respective sound wave corresponds to a respective point sound source.

Embodiments of the present disclosure can include a head wearable device. For example, the head wearable device can include a front frame, a display coupled to the front frame, an arm coupled to the front frame and configured to attach the head wearable device to a user's head, and an acoustic waveguide. In some embodiments, the acoustic waveguide can include an audio source, a decoder coupled to the audio source and configured to produce an audio signal, a digital signal processor (DSP) configured to receive the audio signal from the decoder and generate a beamformed signal, a plurality of acoustic vents disposed on a lower surface of the waveguide, and a plurality of audio transducers. In some embodiments, each audio transducer disposed in a respective acoustic vent of the plurality of acoustic vents, wherein each audio transducer receives a discrete output signal that has been phase correlated to produce a directive audio wave.

Embodiments of the present disclosure can include methods for presenting audio signals. According to one or more embodiments, the methods can include: emitting, via a sound source, one or more acoustic waves of an audio signal into a waveguide member of an acoustic waveguide, receiving, at a first acoustic vent, the one or more acoustic waves, wherein the first acoustic vent is disposed on a lower surface of the waveguide member, generating a first point sound source at the first acoustic vent based on the one or more acoustic waves, receiving, at a second acoustic vent, the one or more acoustic waves, wherein the second acoustic vent is disposed on the lower surface of the waveguide member, generating a second point sound source at the second acoustic vent based on the one or more acoustic waves, and presenting the first point sound source and the second point sound source.

### BRIEF DESCRIPTION OF THE DRAWINGS

FIGS. 1A-1C illustrate an example mixed reality environment, according to one or more embodiments of the disclosure.

FIGS. 2A-2D illustrate components of an example mixed reality system that can be used to generate and interact with a mixed reality environment, according to one or more embodiments of the disclosure.

FIG. 3A illustrates an example mixed reality handheld controller that can be used to provide input to a mixed reality environment, according to one or more embodiments of the disclosure.

FIG. 3B illustrates an example auxiliary unit that can be used with an example mixed reality system, according to one or more embodiments of the disclosure.

FIG. 4 illustrates an example functional block diagram for an example mixed reality system, according to one or more embodiments of the disclosure.

FIGS. 5A-5B illustrate exemplary acoustic waveguides, according to one or more embodiments of the disclosure.

FIGS. 6A-6D illustrate exemplary acoustic waveguides for a mixed reality system, according to one or more embodiments of the disclosure.

FIG. 7A illustrates an exemplary block diagram of a process for operating a speaker system, according to one or more embodiments of the disclosure.

FIG. 7B-7D illustrate exemplary audio radiation patterns, according to one or more embodiments of the disclosure.

FIG. 8 illustrates an exemplary acoustic waveguide for a mixed reality system, according to one or more embodiments of the disclosure.

FIG. 9 illustrates an exemplary acoustic waveguide for a mixed reality system, according to one or more embodiments of the disclosure.

FIGS. 10A-10B illustrate exemplary speaker systems for a mixed reality system, according to one or more embodiments of the disclosure.

FIG. 11 illustrates an exemplary block diagram of a process for operating a speaker system, according to one or more embodiments of the disclosure.

FIG. 12 illustrates an exemplary mixed reality system, according to one or more embodiments of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

### Mixed Reality Environment

Like all people, a user of a mixed reality system exists in a real environment that is, a three-dimensional portion of the “real world,” and all of its contents, that are perceptible by the user. For example, a user perceives a real environment using one's ordinary human senses sight, sound, touch, taste, smell and interacts with the real environment by moving one's own body in the real environment. Locations in a real environment can be described as coordinates in a coordinate space; for example, a coordinate can comprise latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time t0, based on data associated with the virtual environment and/or input provided by a user, a state of the virtual environment at a second time t1. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time t1. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include only some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate for instance, an audio signal corresponding to a composite of sounds in the virtual environment, and mixed and processed to simulate an audio signal that would be heard by a listener at the listener coordinate and present the audio signal to a user via one or more speakers.

Because a virtual environment exists only as a computational structure, a user cannot directly perceive a virtual environment using one's ordinary senses. Instead, a user can perceive a virtual environment only indirectly, as presented to the user, for example by a display, speakers, haptic output devices, etc. Similarly, a user cannot directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A mixed reality system can present to the user, for example using a transmissive display and/or one or more speakers (which may, for example, be incorporated into a wearable head device), a mixed reality environment (“MRE”) that combines aspects of a real environment and a virtual environment. In some embodiments, the one or more speakers may be external to the head-mounted wearable unit. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE comprises a real lamp post (a real object) at a location coordinate, the virtual environment of the MRE may comprise a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may comprise a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may comprise a green, two-armed cactus a prickly inanimate object a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment because, as noted above, a user cannot directly perceive or interact with a virtual environment a user of an MR system may find it intuitive and natural to interact with a virtual object by seeing, hearing, and touching a corresponding real object in his or her own real environment. This level of interactivity can heighten a user's feelings of immersion, connection, and engagement with a virtual environment. Similarly, by simultaneously presenting a real environment and a virtual environment, mixed reality systems can reduce negative psychological feelings (e.g., cognitive dissonance) and negative physical feelings (e.g., motion sickness) associated with VR systems. Mixed reality systems further offer many possibilities for applications that may augment or alter our experiences of the real world.

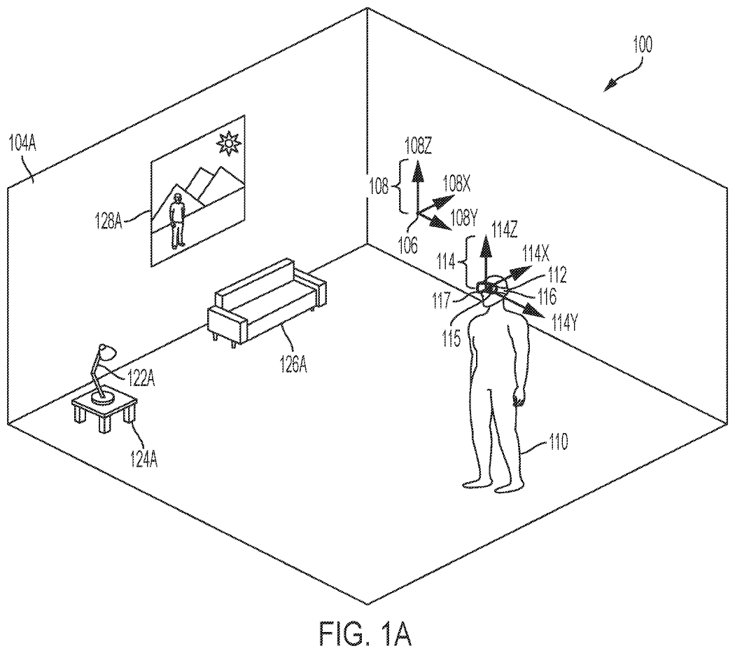

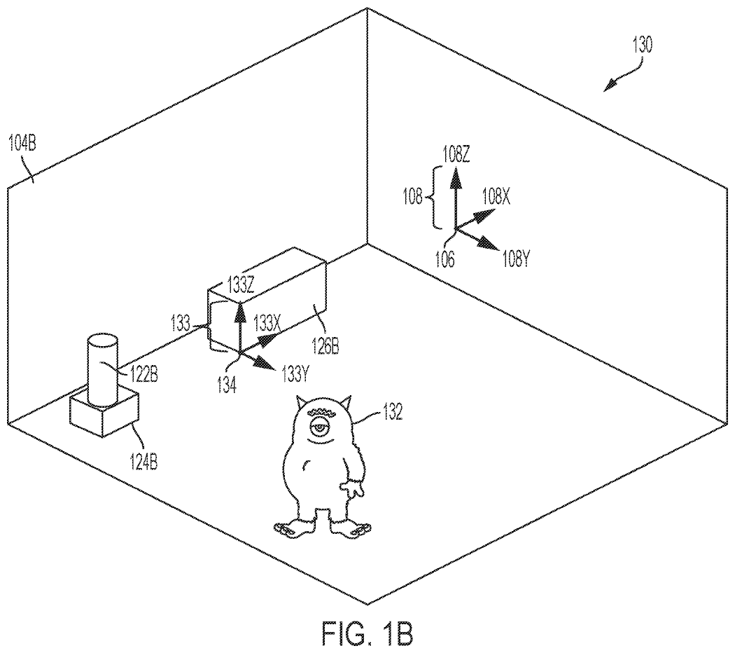

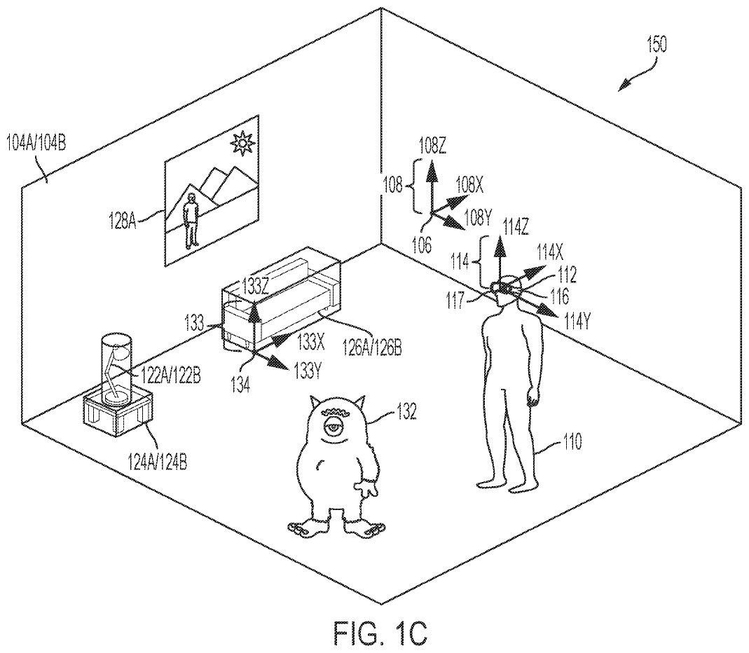

FIG. 1A illustrates an example real environment 100 in which a user 110 uses a mixed reality system 112. Mixed reality system 112 may comprise a display (e.g., a transmissive display) and one or more speakers, and one or more sensors (e.g., a camera), for example as described below. The real environment 100 shown comprises a rectangular room 104A, in which user 110 is standing; and real objects 122A (a lamp), 124A (a table), 126A (a sofa), and 128A (a painting). Room 104A further comprises a location coordinate 106, which may be considered an origin of the real environment 100. As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a Quaternion matrix or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a Quaternion matrix or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an example virtual environment 130 that corresponds to real environment 100. The virtual environment 130 shown comprises a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, and 126A. Virtual environment 130 additionally comprises a virtual monster 132, which does not correspond to any real object in real environment 100. Real object 128A in real environment 100 does not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a Quaternion matrix or other rotation matrix), or other suitable representation can characterize a transformation between the persistent coordinate system 133 space and the environment/world coordinate system 108 space. In some embodiments, each of the virtual objects 122B, 124B, 126B, and 132 may have their own persistent coordinate point relative to the origin point 134 of the persistent coordinate system 133. In some embodiments, there may be multiple persistent coordinate systems and each of the virtual objects 122B, 124B, 126B, and 132 may have their own persistent coordinate point relative to one or more persistent coordinate systems.

Persistent coordinate data may be coordinate data that persists relative to a physical environment. Persistent coordinate data may be used by MR systems (e.g., MR system 112, 200) to place persistent virtual content, which may not be tied to movement of a display on which the virtual object is being displayed. For example, a two-dimensional screen may only display virtual objects relative to a position on the screen. As the two-dimensional screen moves, the virtual content may move with the screen. In some embodiments, persistent virtual content may be displayed in a corner of a room. A MR user may look at the corner, see the virtual content, look away from the corner (where the virtual content may no longer be visible because the virtual content may have moved from within the user's field of view to a location outside the user's field of view due to motion of the user's head), and look back to see the virtual content in the corner (similar to how a real object may behave).

In some embodiments, persistent coordinate data (e.g., a persistent coordinate system and/or a persistent coordinate frame) can include an origin point and three axes. For example, a persistent coordinate system may be assigned to a center of a room by a MR system. In some embodiments, a user may move around the room, out of the room, re-enter the room, etc., and the persistent coordinate system may remain at the center of the room (e.g., because it persists relative to the physical environment). In some embodiments, a virtual object may be displayed using a transform to persistent coordinate data, which may enable displaying persistent virtual content. In some embodiments, a MR system may use simultaneous localization and mapping to generate persistent coordinate data (e.g., the MR system may assign a persistent coordinate system to a point in space). In some embodiments, a MR system may map an environment by generating persistent coordinate data at regular intervals (e.g., a MR system may assign persistent coordinate systems in a grid where persistent coordinate systems may be at least within five feet of another persistent coordinate system).

In some embodiments, persistent coordinate data may be generated by a MR system and transmitted to a remote server. In some embodiments, a remote server may be configured to receive persistent coordinate data. In some embodiments, a remote server may be configured to synchronize persistent coordinate data from multiple observation instances. For example, multiple MR systems may map the same room with persistent coordinate data and transmit that data to a remote server. In some embodiments, the remote server may use this observation data to generate canonical persistent coordinate data, which may be based on the one or more observations. In some embodiments, canonical persistent coordinate data may be more accurate and/or reliable than a single observation of persistent coordinate data. In some embodiments, canonical persistent coordinate data may be transmitted to one or more MR systems. For example, a MR system may use image recognition and/or location data to recognize that it is located in a room that has corresponding canonical persistent coordinate data (e.g., because other MR systems have previously mapped the room). In some embodiments, the MR system may receive canonical persistent coordinate data corresponding to its location from a remote server.

With respect to FIGS. 1A and 1, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a Quaternion matrix or other rotation matrix), or other suitable representation can characterize a transformation between a real environment coordinate space and a virtual environment coordinate space.

FIG. 1C illustrates an example MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As above, origin point 106 acts as an origin for a coordinate space corresponding to MRE 150, and coordinate system 108 defines an x-axis, y-axis, and z-axis for the coordinate space.

In the example shown, mixed reality objects comprise corresponding pairs of real objects and virtual objects (i.e., 122A/122B, 124A/124B, 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described above may also incorporate audio aspects. For instance, in MIRE 150, virtual monster 132 could be associated with one or more audio signals, such as a footstep sound effect that is generated as the monster walks around MRE 150. As described further below, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

### Example Mixed Reality System

Example mixed reality system 112 can include a wearable head device (e.g., a wearable augmented reality or mixed reality head device) comprising a display (which may comprise left and right transmissive displays, which may be near-eye displays, and associated components for coupling light from the displays to the user's eyes); left and right speakers (e.g., positioned adjacent to the user's left and right ears, respectively); an inertial measurement unit (IMU)(e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability) to communicate with other devices and systems, including other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described further below.

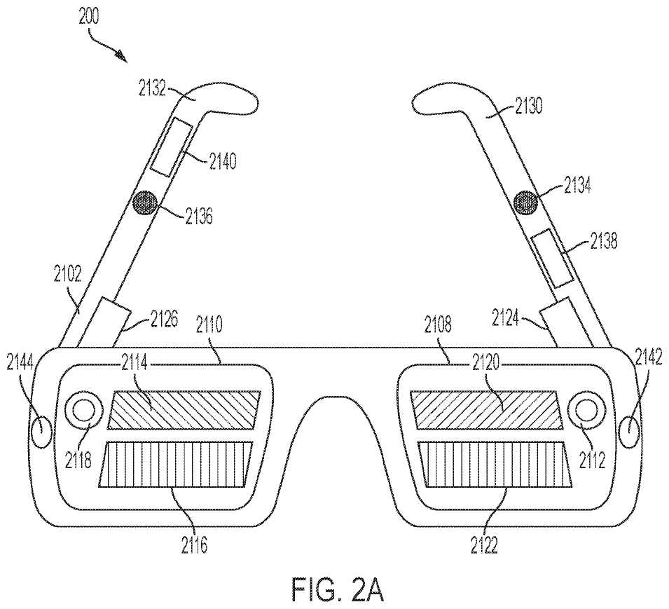

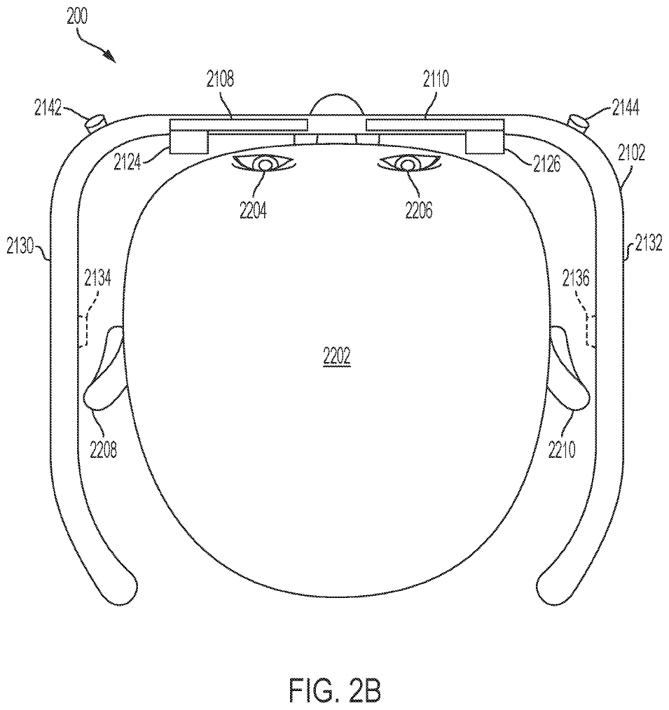

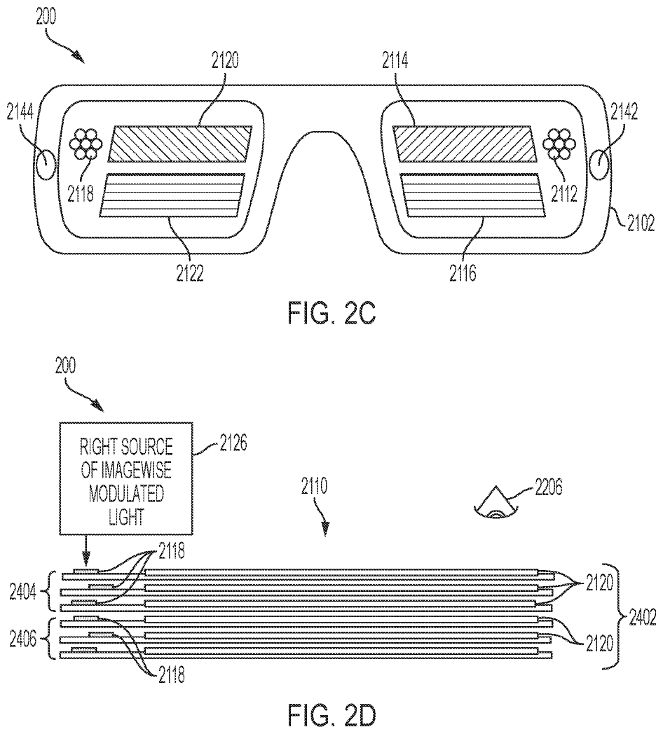

FIGS. 2A-2D illustrate components of an example mixed reality system 200 (which may correspond to mixed reality system 112) that may be used to present a MRE (which may correspond to MIRE 150), or other virtual environment, to a user. FIG. 2A illustrates a perspective view of a wearable head device 2102 included in example mixed reality system 200. FIG. 2B illustrates a top view of wearable head device 2102 worn on a user's head 2202. FIG. 2C illustrates a front view of wearable head device 2102. FIG. 2D illustrates an edge view of example eyepiece 2110 of wearable head device 2102. As shown in FIGS. 2A-2C, the example wearable head device 2102 includes an example left eyepiece (e.g., a left transparent waveguide set eyepiece) 2108 and an example right eyepiece (e.g., a right transparent waveguide set eyepiece) 2110. Each eyepiece 2108 and 2110 can include transmissive elements through which a real environment can be visible, as well as display elements for presenting a display (e.g., via imagewise modulated light) overlapping the real environment. In some examples, such display elements can include surface diffractive optical elements for controlling the flow of imagewise modulated light. For instance, the left eyepiece 2108 can include a left in-coupling grating set 2112, a left orthogonal pupil expansion (OPE) grating set 2120, and a left exit (output) pupil expansion (EPE) grating set 2122. As used herein, a pupil may refer to the exit of light from an optical element such as a grating set or reflector. Similarly, the right eyepiece 2110 can include a right in-coupling grating set 2118, a right OPE grating set 2114 and a right EPE grating set 2116. Imagewise modulated light can be transferred to a user's eye via the in-coupling gratings 2112 and 2118, OPEs 2114 and 2120, and EPE 2116 and 2122. Each in-coupling grating set 2112, 2118 can be configured to deflect light toward its corresponding OPE grating set 2120, 2114. Each OPE grating set 2120, 2114 can be designed to incrementally deflect light down toward its associated EPE 2122, 2116, thereby horizontally extending an exit pupil being formed. Each EPE 2122, 2116 can be configured to incrementally redirect at least a portion of light received from its corresponding OPE grating set 2120, 2114 outward to a user eyebox position (not shown) defined behind the eyepieces 2108, 2110, vertically extending the exit pupil that is formed at the eyebox. Alternatively, in lieu of the in-coupling grating sets 2112 and 2118, OPE grating sets 2114 and 2120, and EPE grating sets 2116 and 2122, the eyepieces 2108 and 2110 can include other arrangements of gratings and/or refractive and reflective features for controlling the coupling of imagewise modulated light to the user's eyes.

In some examples, wearable head device 2102 can include a left temple arm 2130 and a right temple arm 2132, where the left temple arm 2130 includes a left speaker 2134 and the right temple arm 2132 includes a right speaker 2136. An orthogonal coil electromagnetic receiver 2138 can be located in the left temple piece, or in another suitable location in the wearable head unit 2102. An Inertial Measurement Unit (IMU) 2140 can be located in the right temple arm 2132, or in another suitable location in the wearable head device 2102. The wearable head device 2102 can also include a left depth (e.g., time-of-flight) camera 2142 and a right depth camera 2144. The depth cameras 2142, 2144 can be suitably oriented in different directions so as to together cover a wider field of view.

In the example shown in FIGS. 2A-2D, a left source of imagewise modulated light 2124 can be optically coupled into the left eyepiece 2108 through the left in-coupling grating set 2112, and a right source of imagewise modulated light 2126 can be optically coupled into the right eyepiece 2110 through the right in-coupling grating set 2118. Sources of imagewise modulated light 2124, 2126 can include, for example, optical fiber scanners; projectors including electronic light modulators such as Digital Light Processing (DLP) chips or Liquid Crystal on Silicon (LCoS) modulators; or emissive displays, such as micro Light Emitting Diode (LED) or micro Organic Light Emitting Diode (OLED) panels coupled into the in-coupling grating sets 2112, 2118 using one or more lenses per side. The input coupling grating sets 2112, 2118 can deflect light from the sources of imagewise modulated light 2124, 2126 to angles above the critical angle for Total Internal Reflection (TIR) for the eyepieces 2108, 2110. The OPE grating sets 2114, 2120 incrementally deflect light propagating by TIR down toward the EPE grating sets 2116, 2122. The EPE grating sets 2116, 2122 incrementally couple light toward the user's face, including the pupils of the user's eyes.

In some examples, as shown in FIG. 2D, each of the left eyepiece 2108 and the right eyepiece 2110 includes a plurality of waveguides 2402. For example, each eyepiece 2108, 2110 can include multiple individual waveguides, each dedicated to a respective color channel (e.g., red, blue and green). In some examples, each eyepiece 2108, 2110 can include multiple sets of such waveguides, with each set configured to impart different wavefront curvature to emitted light. The wavefront curvature may be convex with respect to the user's eyes, for example to present a virtual object positioned a distance in front of the user (e.g., by a distance corresponding to the reciprocal of wavefront curvature). In some examples, EPE grating sets 2116, 2122 can include curved grating grooves to effect convex wavefront curvature by altering the Poynting vector of exiting light across each EPE.

In some examples, to create a perception that displayed content is three-dimensional, stereoscopically-adjusted left and right eye imagery can be presented to the user through the imagewise light modulators 2124, 2126 and the eyepieces 2108, 2110. The perceived realism of a presentation of a three-dimensional virtual object can be enhanced by selecting waveguides (and thus corresponding the wavefront curvatures) such that the virtual object is displayed at a distance approximating a distance indicated by the stereoscopic left and right images. This technique may also reduce motion sickness experienced by some users, which may be caused by differences between the depth perception cues provided by stereoscopic left and right eye imagery, and the autonomic accommodation (e.g., object distance-dependent focus) of the human eye.

FIG. 2D illustrates an edge-facing view from the top of the right eyepiece 2110 of example wearable head device 2102. As shown in FIG. 2D, the plurality of waveguides 2402 can include a first subset of three waveguides 2404 and a second subset of three waveguides 2406. The two subsets of waveguides 2404, 2406 can be differentiated by different EPE gratings featuring different grating line curvatures to impart different wavefront curvatures to exiting light. Within each of the subsets of waveguides 2404, 2406 each waveguide can be used to couple a different spectral channel (e.g., one of red, green and blue spectral channels) to the user's right eye 2206. (Although not shown in FIG. 2D, the structure of the left eyepiece 2108 is analogous to the structure of the right eyepiece 2110.)

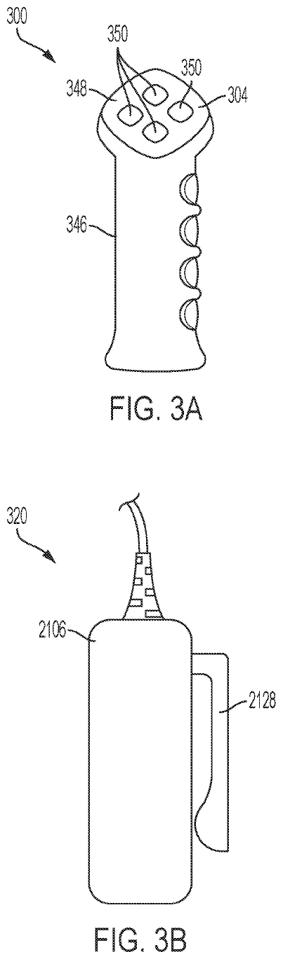

FIG. 3A illustrates an example handheld controller component 300 of a mixed reality system 200. In some examples, handheld controller 300 includes a grip portion 346 and one or more buttons 350 disposed along a top surface 348. In some examples, buttons 350 may be configured for use as an optical tracking target, e.g., for tracking six-degree-of-freedom (6DOF) motion of the handheld controller 300, in conjunction with a camera or other optical sensor (which may be mounted in a head unit (e.g., wearable head device 2102) of mixed reality system 200). In some examples, handheld controller 300 includes tracking components (e.g., an IMU or other suitable sensors) for detecting position or orientation, such as position or orientation relative to wearable head device 2102. In some examples, such tracking components may be positioned in a handle of handheld controller 300, and/or may be mechanically coupled to the handheld controller. Handheld controller 300 can be configured to provide one or more output signals corresponding to one or more of a pressed state of the buttons; or a position, orientation, and/or motion of the handheld controller 300 (e.g., via an IMU). Such output signals may be used as input to a processor of mixed reality system 200. Such input may correspond to a position, orientation, and/or movement of the handheld controller (and, by extension, to a position, orientation, and/or movement of a hand of a user holding the controller). Such input may also correspond to a user pressing buttons 350.

FIG. 3B illustrates an example auxiliary unit 320 of a mixed reality system 200. The auxiliary unit 320 can include a battery to provide energy to operate the system 200, and can include a processor for executing programs to operate the system 200. As shown, the example auxiliary unit 320 includes a clip 2128, such as for attaching the auxiliary unit 320 to a user's belt. Other form factors are suitable for auxiliary unit 320 and will be apparent, including form factors that do not involve mounting the unit to a user's belt. In some examples, auxiliary unit 320 is coupled to the wearable head device 2102 through a multiconduit cable that can include, for example, electrical wires and fiber optics. Wireless connections between the auxiliary unit 320 and the wearable head device 2102 can also be used.

In some examples, mixed reality system 200 can include one or more microphones to detect sound and provide corresponding signals to the mixed reality system. In some examples, a microphone may be attached to, or integrated with, wearable head device 2102, and may be configured to detect a user's voice. In some examples, a microphone may be attached to, or integrated with, handheld controller 300 and/or auxiliary unit 320. Such a microphone may be configured to detect environmental sounds, ambient noise, voices of a user or a third party, or other sounds.

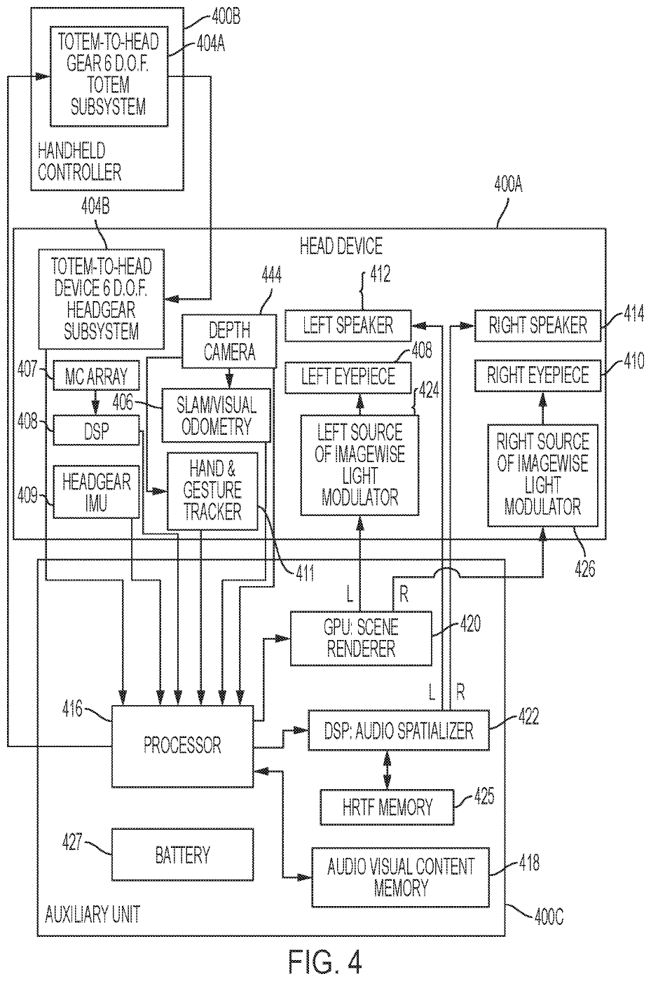

FIG. 4 shows an example functional block diagram that may correspond to an example mixed reality system, such as mixed reality system 200 described above (which may correspond to mixed reality system 112 with respect to FIG. 1). As shown in FIG. 4, example handheld controller 400B (which may correspond to handheld controller 300 (a “totem”)) includes a totem-to-wearable head device six degree of freedom (6DOF) totem subsystem 404A and example wearable head device 400A (which may correspond to wearable head device 2102) includes a totem-to-wearable head device 6DOF subsystem 404B. In the example, the 6DOF totem subsystem 404A and the 6DOF subsystem 404B cooperate to determine six coordinates (e.g., offsets in three translation directions and rotation along three axes) of the handheld controller 400B relative to the wearable head device 400A. The six degrees of freedom may be expressed relative to a coordinate system of the wearable head device 400A. The three translation offsets may be expressed as X, Y, and Z offsets in such a coordinate system, as a translation matrix, or as some other representation. The rotation degrees of freedom may be expressed as sequence of yaw, pitch and roll rotations, as a rotation matrix, as a quaternion, or as some other representation. In some examples, the wearable head device 400A; one or more depth cameras 444 (and/or one or more non-depth cameras) included in the wearable head device 400A; and/or one or more optical targets (e.g., buttons 350 of handheld controller 400B as described above, or dedicated optical targets included in the handheld controller 400B) can be used for 6DOF tracking. In some examples, the handheld controller 400B can include a camera, as described above; and the wearable head device 400A can include an optical target for optical tracking in conjunction with the camera. In some examples, the wearable head device 400A and the handheld controller 400B each include a set of three orthogonally oriented solenoids, which are used to wirelessly send and receive three distinguishable signals. By measuring the relative magnitude of the three distinguishable signals received in each of the coils used for receiving, the 6DOF of the wearable head device 400A relative to the handheld controller 400B may be determined. Additionally, 6DOF totem subsystem 404A can include an Inertial Measurement Unit (IMU) that is useful to provide improved accuracy and/or more timely information on rapid movements of the handheld controller 400B.

In some embodiments, wearable system 400 can include microphone array 407, which can include one or more microphones arranged on headgear device 400A. In some embodiments, microphone array 407 can include four microphones. Two microphones can be placed on a front face of headgear 400A, and two microphones can be placed at a rear of head headgear 400A (e.g., one at a back-left and one at a back-right). In some embodiments, signals received by microphone array 407 can be transmitted to DSP 408. DSP 408 can be configured to perform signal processing on the signals received from microphone array 407. For example, DSP 408 can be configured to perform noise reduction, acoustic echo cancellation, and/or beamforming on signals received from microphone array 407. DSP 408 can be configured to transmit signals to processor 416.

In some examples, it may become necessary to transform coordinates from a local coordinate space (e.g., a coordinate space fixed relative to the wearable head device 400A) to an inertial coordinate space (e.g., a coordinate space fixed relative to the real environment), for example in order to compensate for the movement of the wearable head device 400A relative to the coordinate system 108. For instance, such transformations may be necessary for a display of the wearable head device 400A to present a virtual object at an expected position and orientation relative to the real environment (e.g., a virtual person sitting in a real chair, facing forward, regardless of the wearable head device's position and orientation), rather than at a fixed position and orientation on the display (e.g., at the same position in the right lower corner of the display), to preserve the illusion that the virtual object exists in the real environment (and does not, for example, appear positioned unnaturally in the real environment as the wearable head device 400A shifts and rotates). In some examples, a compensatory transformation between coordinate spaces can be determined by processing imagery from the depth cameras 444 using a SLAM and/or visual odometry procedure in order to determine the transformation of the wearable head device 400A relative to the coordinate system 108. In the example shown in FIG. 4, the depth cameras 444 are coupled to a SLAM/visual odometry block 406 and can provide imagery to block 406. The SLAM/visual odometry block 406 implementation can include a processor configured to process this imagery and determine a position and orientation of the user's head, which can then be used to identify a transformation between a head coordinate space and another coordinate space (e.g., an inertial coordinate space). Similarly, in some examples, an additional source of information on the user's head pose and location is obtained from an IMU 409. Information from the IMU 409 can be integrated with information from the SLAM/visual odometry block 406 to provide improved accuracy and/or more timely information on rapid adjustments of the user's head pose and position.

In some examples, the depth cameras 444 can supply 3D imagery to a hand gesture tracker 411, which may be implemented in a processor of the wearable head device 400A. The hand gesture tracker 411 can identify a user's hand gestures, for example by matching 3D imagery received from the depth cameras 444 to stored patterns representing hand gestures. Other suitable techniques of identifying a user's hand gestures will be apparent.

In some examples, one or more processors 416 may be configured to receive data from the wearable head device's 6DOF headgear subsystem 404B, the IMU 409, the SLAM/visual odometry block 406, depth cameras 444, and/or the hand gesture tracker 411. The processor 416 can also send and receive control signals from the 6DOF totem system 404A. The processor 416 may be coupled to the 6DOF totem system 404A wirelessly, such as in examples where the handheld controller 400B is untethered. Processor 416 may further communicate with additional components, such as an audio-visual content memory 418, a Graphical Processing Unit (GPU) 420, and/or a Digital Signal Processor (DSP) audio spatializer 422. The DSP audio spatializer 422 may be coupled to a Head Related Transfer Function (HRTF) memory 425. The GPU 420 can include a left channel output coupled to the left source of imagewise modulated light 424 and a right channel output coupled to the right source of imagewise modulated light 426. GPU 420 can output stereoscopic image data to the sources of imagewise modulated light 424, 426, for example as described above with respect to FIGS. 2A-2D. The DSP audio spatializer 422 can output audio to a left speaker 412 and/or a right speaker 414. The DSP audio spatializer 422 can receive input from processor 419 indicating a direction vector from a user to a virtual sound source (which may be moved by the user, e.g., via the handheld controller 320). Based on the direction vector, the DSP audio spatializer 422 can determine a corresponding HRTF (e.g., by accessing a HRTF, or by interpolating multiple HRTFs). The DSP audio spatializer 422 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment that is, by presenting a virtual sound that matches a user's expectations of what that virtual sound would sound like if it were a real sound in a real environment.

In some examples, such as shown in FIG. 4, one or more of processor 416, GPU 420, DSP audio spatializer 422, HRTF memory 425, and audio/visual content memory 418 may be included in an auxiliary unit 400C (which may correspond to auxiliary unit 320 described above). The auxiliary unit 400C may include a battery 427 to power its components and/or to supply power to the wearable head device 400A or handheld controller 400B. Including such components in an auxiliary unit, which can be mounted to a user's waist, can limit the size and weight of the wearable head device 400A, which can in turn reduce fatigue of a user's head and neck.

While FIG. 4 presents elements corresponding to various components of an example mixed reality system, various other suitable arrangements of these components will become apparent to those skilled in the art. For example, elements presented in FIG. 4 as being associated with auxiliary unit 400C could instead be associated with the wearable head device 400A or handheld controller 400B. Furthermore, some mixed reality systems may forgo entirely a handheld controller 400B or auxiliary unit 400C. Such changes and modifications are to be understood as being included within the scope of the disclosed examples.

### Acoustic Waveguide

Because XR systems (e.g., MR system 112, 200) blend together real content with virtual content, true immersion may rely on engaging as many of a user's senses as possible. In some instances, creating realistic sounds can include subtleties that are difficult to replicate with audio signal processing. For example, in a real world environment, sound is generally received by an individual's ear via a frontal incidence wavefront. The frontal incidence wavefront can interact with an individual's pinna, i.e., the fleshy visible outer part of the ear, which can impart a unique acoustic signature to external sounds heard by the individual. When a sound source, e.g., speaker, is mounted near the entrance of the user's ear canal in an over-ear or in-ear configuration, as is typical in XR headsets, the sound received by the user may not include the unique acoustic signature of their pinna, which can detract from a user's immersive XR experience.

Moreover, placing the audio transducer of the speaker near a user's ear can add bulk and weight to the arms of the head mounted display, which can be uncomfortable when a user's ear is supporting that weight. Additionally, some speaker systems may be prone to sound leakage, such that other individuals in the vicinity can hear the sound produced by the speakers. Sound leakage cannot only be annoying for the user and other individuals, but it can also interfere with a user's audio privacy. Thus, it can be desirable to provide a sound system that can provide sound incidence that will include a user's pinna acoustic signature with minimal sound leakage.

Embodiments of the present disclosure are directed to an acoustic waveguide for presenting an audio signal and a method of use. Acoustic waveguides in accordance with embodiments of the present disclosure can provide a frontal sound incidence to a user such that the sound perceived by a user may include the acoustic signature of the user's pinna. Embodiments of the present disclosure may also provide minimal sound leakage due to the sound source directivity of the acoustic waveguide. An apparatus in accordance with embodiments of this disclosure can include a waveguide member comprising a hollow body having a first end and a second end. The apparatus can further include a sound source disposed at the first end of the waveguide configured to emit at least a first sound wave. The apparatus can further include a plurality of acoustic vents disposed on a lower surface of the body of the waveguide, wherein each of the plurality of acoustic vents is configured to receive the first sound wave and further configured to emit a respective sound wave based on the first sound wave, wherein each respective sound wave corresponds to a respective point sound source.

Embodiments of the present disclosure can include a head wearable device. For example, the head wearable device can include a front frame, a display coupled to the front frame, an arm coupled to the front frame and configured to attach the head wearable device to a user's head, and an acoustic waveguide. In one or more examples, the acoustic waveguide can include a waveguide member comprising a hollow body having a first end and a second end, a sound source disposed at the first end of the waveguide, and a plurality of acoustic vents disposed on a lower surface of the body of the waveguide, wherein each of the plurality of acoustic vents is configured to receive the first sound wave and further to emit a respective sound wave based on the first sound wave, wherein each respective sound wave corresponds to a respective point sound source.

Embodiments of the present disclosure can include methods for presenting audio signals. According to one or more embodiments, the methods can include: emitting, via a sound source, one or more acoustic waves of an audio signal into a waveguide member of an acoustic waveguide, receiving, at a first acoustic vent, the one or more acoustic waves, wherein the first acoustic vent is disposed on a lower surface of the waveguide member, generating a first point sound source at the first acoustic vent based on the one or more acoustic waves, receiving, at a second acoustic vent, the one or more acoustic waves, wherein the second acoustic vent is disposed on the lower surface of the waveguide member, generating a second point sound source at the second acoustic vent based on the one or more acoustic waves, and presenting the first point sound source and the second point sound source.

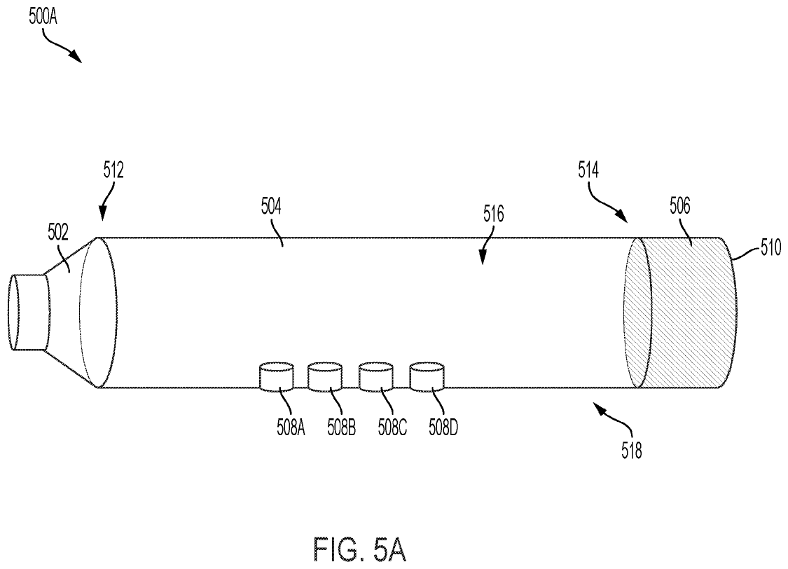

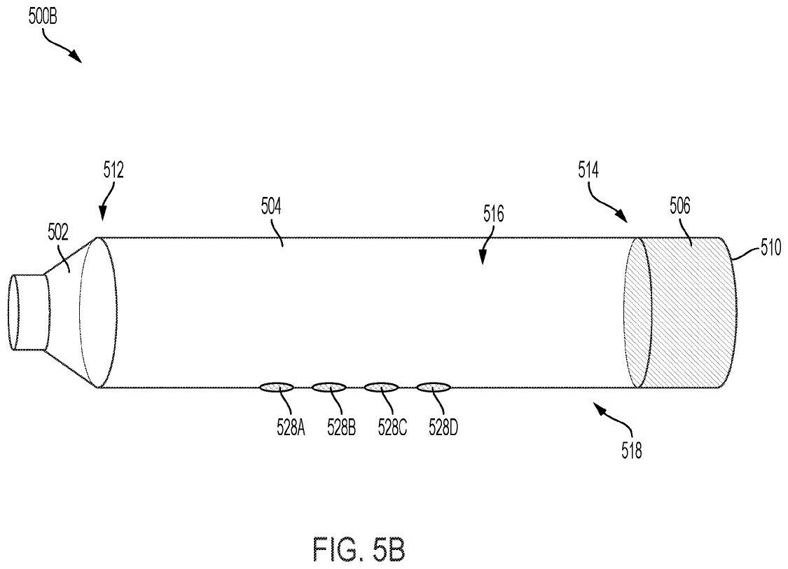

FIG. 5A illustrates an exemplary acoustic waveguide 500A, according to one or more embodiments of the present disclosure. In some embodiments, the acoustic waveguide can be integrated into a wearable head device, as discussed in greater detail below. An acoustic waveguide 500A according to embodiments of the present disclosure can include one or more sound sources 502, a waveguide 504, a sound absorber 506, and one or more acoustic vents 508a-508d.

The waveguide 504 can correspond to a hollow body having a first end 512 and a second end 514. In some embodiments, the first end 512 may include an opening that provides access to an interior of the hollow body. In some embodiments, the first end 512 may be closed. In some embodiments, the second end 514 may be closed. In such embodiments, the second end may include a back surface 510 that covers the opening at the second end 514. The waveguide 504 can further include an upper surface region 516 and a lower surface region 518.

As shown in the figure, the waveguide 504 can correspond to a cylindrical, e.g., tubular hollow body, having a circular cross-section. However, a skilled artisan will understand that the shape of the waveguide 504 is not intended to limit the scope of this disclosure. For example, the waveguide 504 can comprise a cross-section with an oval, triangular, rectangular, diamond, trapezoidal, and/or irregular shape. In some embodiments, the cross-section of the waveguide 504 can vary along the length of the waveguide, e.g., such that an area of a cross-section of the waveguide taken near to the first end 512 can correspond a first cross-sectional shape and/or first area, while the area of a cross-section of the waveguide taken closer to the second end 514 can correspond a second cross-sectional shape and/or second area, different from the first cross-sectional shape and/or first area.

In some embodiments, the diameter and/or cross-sectional area of the waveguide 504 can be tuned to ensure that particular audio frequencies, e.g., higher frequencies such as 50 Hz to 150 Hz, 50 Hz to 250 Hz, 200 Hz to 500 Hz, 400 Hz to 1 kHz, can be propagated longitudinally along the length of the tube. For example, in one or more embodiments, a narrower diameter, e.g., smaller cross-sectional area, may facilitate the propagation of the one or more acoustic waves as longitudinal waves. This can aid in propagating higher audio frequencies. Moreover, propagation of the one or more acoustic waves as longitudinal waves can ensure the time delay between one or more sound waves exiting adjacent vents, e.g., the first acoustic vent 508a and second acoustic vent 508b, corresponds to the amount of time it takes for the one or more acoustic waves to travel between the adjacent vents. In one or more examples, the diameter and/or cross-sectional area can be tuned by performing one or more simulations of the acoustic waveguide. For instance, the first acoustic vent 508A can be approximately 200% of the cross-sectional volume of the second vent 508B, 400% of the cross-sectional volume of the third vent 508C, and 800% of the cross-sectional volume of the fourth vent 508D. In some examples, the following equation can be used to determine the geometry of the acoustic vents:

$${L}_{v} = \frac{2.35625 \times {10}^{4} {D}_{v}^{2} {N}_{v}}{{V}_{b} {F}_{b}^{2}} - k {D}_{v}$$

Where as Lᵥ is length of the vent, D, is the internal diameter of vent, V_{b} is the internal air volume of the enclosure, F_{b} is the tuning frequency of the enclosure, K is the end correction, and Nᵥ is the number of vents.

In some embodiments, the sound source 502 can be located at a first end 512 of the waveguide 504. As shown in the figure, the sound source 502 may be positioned outside of the waveguide 504 such that the sound source 502 is configured to emit soundwaves into the opening at the first end 512 of the waveguide 504. In some embodiments, the sound source 502 can be positioned inside the waveguide 504. In such embodiments, the first end 512 of the waveguide can be either open or closed. In one or more examples, a diameter of the sound source 502 can correspond to a diameter of the tube. The sound source 502 can be configured to emit sound waves that can be heard by an individual. For example, the sound source can receive one or more signals corresponding to audio content. In some examples, the sound source 502 can be in communication with an audio spatializer, e.g., DSP audio spatializer 422, in order to output an audio signal. In some embodiments, the sound source 502 can be a speaker and/or an audio transducer.

The sound absorber 506 can be disposed at the second end 514 of the waveguide 504. The sound absorber 506 can be configured to absorb sound in the waveguide 504 emitted by the sound source 502. In this manner, the sound absorber 506 may reduce a resonance of a sound wave emitted by the sound source 502 within the waveguide 504. As shown in the figure, the sound absorber 506 can be disposed within the waveguide 504 at the second end 514. In some embodiments, the sound absorber 506 can occupy a region in the second end 514 such that the back surface 510 of the waveguide 504 is covered. In some embodiments, there may be a gap between the sound absorber 106 and an inner surface of the waveguide such that the sound absorber 506 may not completely cover the back surface 510 of the waveguide 504. In one or more embodiments, the sound absorber 506 can be formed from a sound absorptive material. In one or more embodiments, the sound absorptive material can include, for example, but is not limited to, acoustic fabric panels, cotton batting, mineral wool, glass fiber, partially reticulated plastic foam, fully reticulated plastic foam with higher absorption coefficients, multilayer composite materials, and the like.

As shown in the figure, the waveguide 504 can include one or more acoustic vents 508a-508d. In some embodiments, the acoustic vents 508a-508d can be disposed on the lower surface region 518 of the waveguide 504. The acoustic vents 508a-508d can be configured to each radiate the sound emitted by the sound source 502. In this manner, the acoustic vents 508a-508d can be configured to emit sound as separate point sound sources based on an output of a single sound source, e.g., sound source 502. While the figure illustrates four acoustic vents, a skilled artisan will understand that an acoustic waveguide 500A according to embodiments of this disclosure can include more or less acoustic vents.

FIG. 5B illustrates an exemplary acoustic waveguide 500B, according to one or more embodiments of the present disclosure. As shown in the figure acoustic waveguide 500B can be substantially similar to acoustic waveguide 500A. For example, acoustic waveguide 500B can include one or more sound sources 502, a waveguide 504, a sound absorber 506, and one or more acoustic vents 528a-528d. As shown in the figure, the one or more acoustic vents 528a-528d. In some embodiments, one or more of the acoustic vents can include acoustic mesh disposed therein, e.g., across an opening of the acoustic vent. For example, the acoustic mesh can include a micronic acoustic mesh that has at least one selected from a Dutch twill weave pattern or a Dutch plain weave pattern. In some embodiments, the acoustic mesh can have a reverse plain Dutch weave pattern or a multiplex twilled weave with two to five bonded fibers or wire. In some embodiments, the density of the acoustic mesh can vary. In some embodiments, the acoustic mesh can have a property of monofilament material. In some embodiments, the acoustic mesh can include a micronic acoustic mesh with at least one selected from a polyester property, a polyimide property, a polypropelyne property, a polyamide property, a nylon property, and/or a meta-aramid property.

In one or more examples, the distance between the sound source 502 and the first acoustic vent 508a, can be tuned such that lower frequency audio waves radiate minimal energy via the acoustic vent 508a. In one or more examples, the distance between the acoustic vents 508a-508d and/or the diameter of the waveguide 504 can be tuned such that the delay time between each of the acoustic vents 508a-508d corresponds to the time it takes the acoustic wave emitted by the sound source 502 to travel in the waveguide 504. For example, the waveguide 504 can be tuned such that longitudinal waves propagate within a body of the waveguide. In some examples, the one or more sound waves radiating from the acoustic vents 508a-508d can provide improved focused directivity of the sound such that sound leakage is reduced, e.g., by beamforming and/or changing the velocity of the wave with acoustic mesh of various weave geometry, diameter of weave and materials.

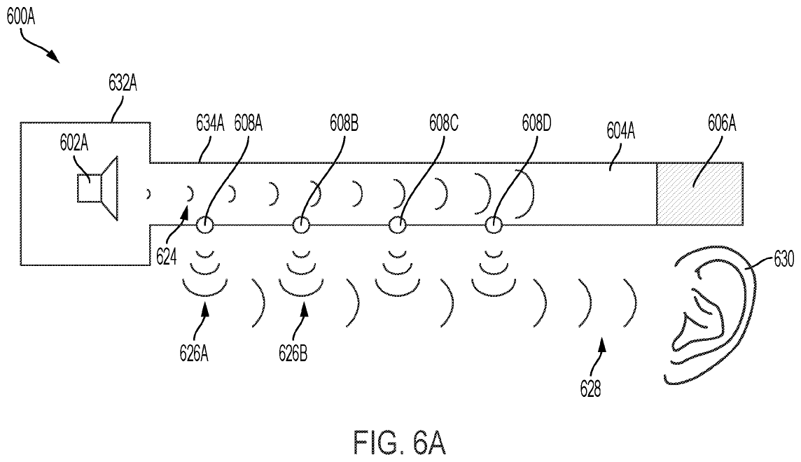

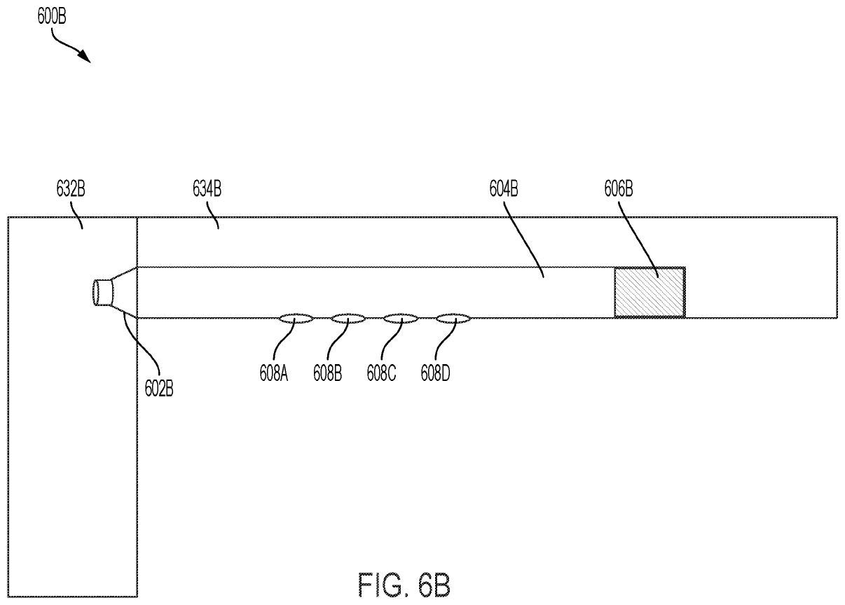

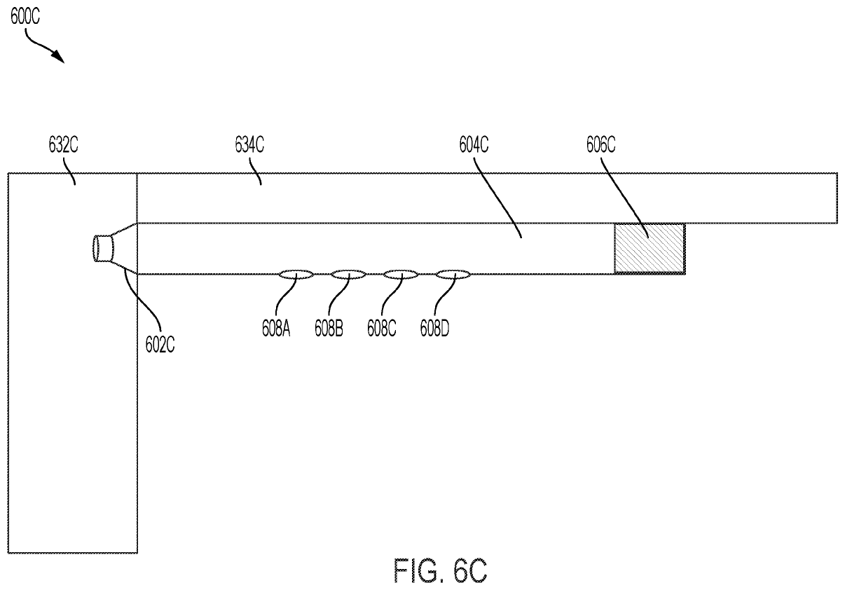

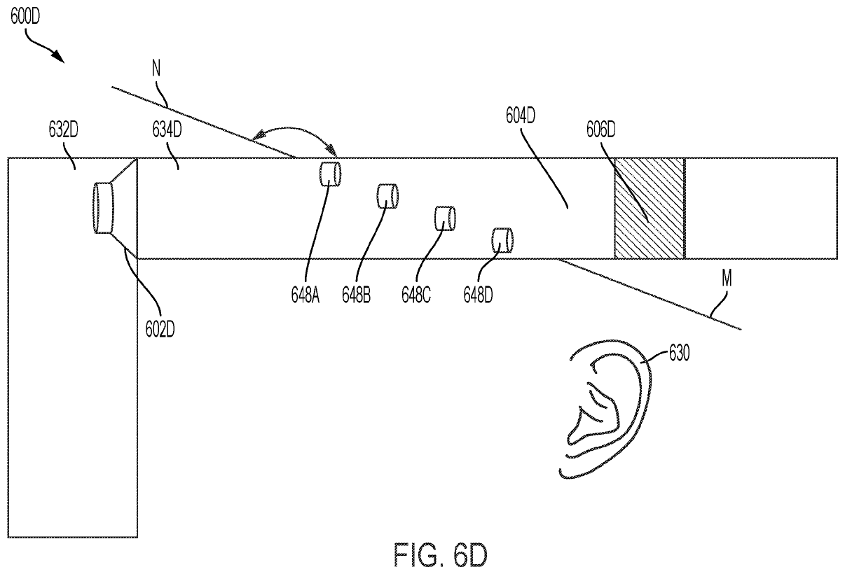

FIG. 6A-6C illustrate examples of acoustic waveguides, e.g., acoustic waveguide 500A, 500B, disposed in a wearable head device (e.g., wearable head device 2102 of mixed reality system 200), according to embodiments of this disclosure. As shown in the figure, the wearable head device can include a frame that comprises a front frame 632A coupled to a temple portion 634A. The front frame 632A can be configured to rest on a nose of a user, while the temple portion 634A can correspond to an arm of the wearable head device that can be configured to rest on an ear of a user. In one or more examples, the acoustic waveguides 600A-600C shown in the figure can correspond to the acoustic waveguide 500A described above.

FIG. 6A illustrates an acoustic waveguide 600A disposed in a wearable head device, according to embodiments of this disclosure. As shown in the figure, the acoustic waveguide 600A can include a sound source 602A, a waveguide 604A, a sound absorber 606A, and one or more acoustic vents 608a-608d. In one or more examples, the acoustic waveguide 600A can correspond to the acoustic waveguide 500A described above. In some embodiments, the sound source 602A can be mounted and/or disposed on the front frame 632A of the wearable head device. In this manner, the weight of the sound source can be distributed to the bridge of the nose, allowing for a more comfortable weight distribution for the user. Additionally, this can enable the temple portion 634A to be thinner and lighter than a temple portion that supports a sound source, e.g., right temple arm 2132 that supports right speaker 2136. As shown in the figure, the waveguide 604A can be disposed in the temple portion 634, e.g., the arm, of a head wearable device. In some embodiments, the hollow body of the waveguide 604A can be positioned within the temple portion 634A. In some embodiments, the hollow body of the waveguide 604A can be formed integrally with the temple portion 634A, such that the outer surfaces of the waveguide 604A correspond to the surfaces of the temple portion 634A.

FIG. 6B illustrates an acoustic waveguide 600B disposed in a wearable head device, according to embodiments of this disclosure. As shown in the figure, the acoustic waveguide 600A can include a sound source 602B, a waveguide 604B, a sound absorber 606B, and one or more acoustic vents 608a-608d. In one or more examples, the acoustic waveguide 600B can correspond to the acoustic waveguide 500A described above. In some embodiments, the sound source 602B can be mounted and/or disposed on the front frame 632B of the wearable head device. In this manner, the weight of the sound source can be distributed to the bridge of the nose, allowing for a more comfortable weight distribution for the user. Additionally, this can enable the temple portion 634B to be thinner and lighter than a temple portion that supports a sound source, e.g., right temple arm 2132 that supports right speaker 2136. As shown in the figure, the waveguide 604B can be disposed in the temple portion 634B, e.g., the arm, of a head wearable device. For example, the hollow body of the waveguide 604B can be positioned within the temple portion 634B. In some embodiments, the hollow body of the waveguide 604B can be formed integrally with the temple portion 634B, such that one or more outer surfaces of the waveguide 604B corresponds to one or more outer surfaces of the temple portion 634B. For example, as shown in the figure, the lower surface of the waveguide 604B can correspond to the lower surface of the temple portion 834B.

FIG. 6C illustrates an acoustic waveguide 600C disposed in a wearable head device, according to embodiments of this disclosure. As shown in the figure, the acoustic waveguide 600C can include a sound source 602C, a waveguide 604C, a sound absorber 606C, and one or more acoustic vents 608a-608d. In one or more examples, the acoustic waveguide 600C can correspond to the acoustic waveguide 500A described above. In some embodiments, the sound source 602C can be mounted and/or disposed on the front frame 632C of the wearable head device. In this manner, the weight of the sound source can be distributed to the bridge of the nose, allowing for a more comfortable weight distribution for the user. Additionally, this can enable the temple portion 634C to be thinner and lighter. As shown in the figure, the waveguide 604C can be attached to a lower surface, e.g., a lower surface, of the temple portion 634C, e.g., the arm, of a head wearable device. In some embodiments, the hollow body of the waveguide 604C can be formed integrally with the temple portion 634C, such that one or more outer surfaces of the waveguide 604C corresponds to one or more outer surfaces of the temple portion 634C.

FIG. 6D illustrates an acoustic waveguide 600D disposed in a wearable head device, according to embodiments of this disclosure. As shown in the figure, the acoustic waveguide 600D can include a sound source 602D, a waveguide 604D, a sound absorber 606D, and one or more acoustic vents 648A-648D. In one or more examples, the acoustic waveguide 6003 can generally correspond to the acoustic waveguide 500D described above. As shown in FIG. 6D, the vents 648A-648D can be located on a temple-side and positioned to provide sound waves in a medial direction, e.g., toward a head of a user wearing the device. In some embodiments, the vents may be angled in a downward direction and/or angled in a direction toward the ear, e.g., at a 45° angle towards the ear (although other angles may be used). Accordingly, the configuration and/or angle of the vents is not intended to limit the scope of this disclosure. In some examples, angle of alignment of the vents can impact the propagation direction of the sound waves. For example, the configuration of acoustic vents 648A-648D can generate a bi-pole with an angle corresponding to line M-N. In some embodiments, mesh impedance can further impact the propagation direction.

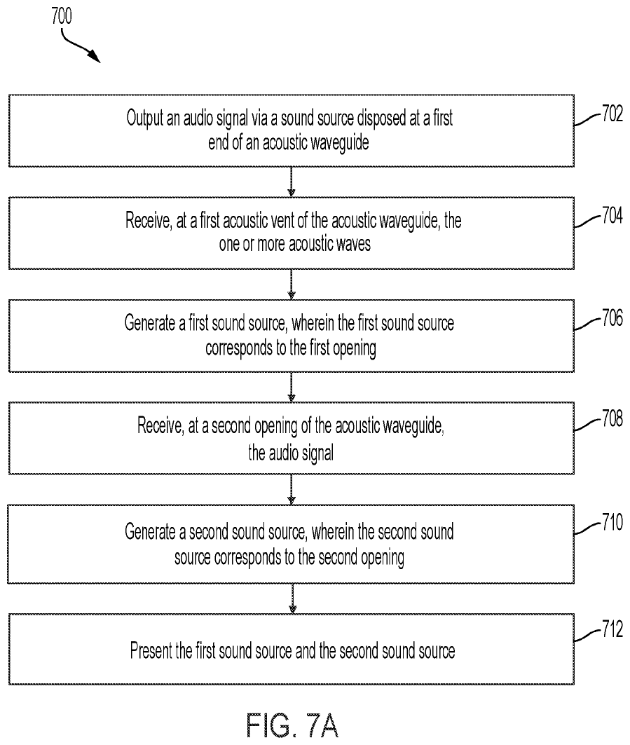

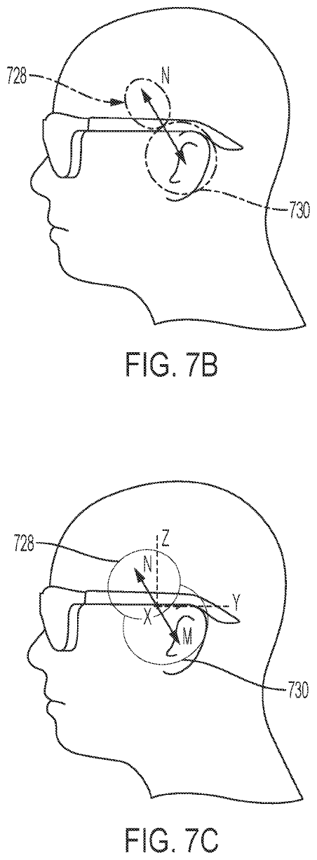

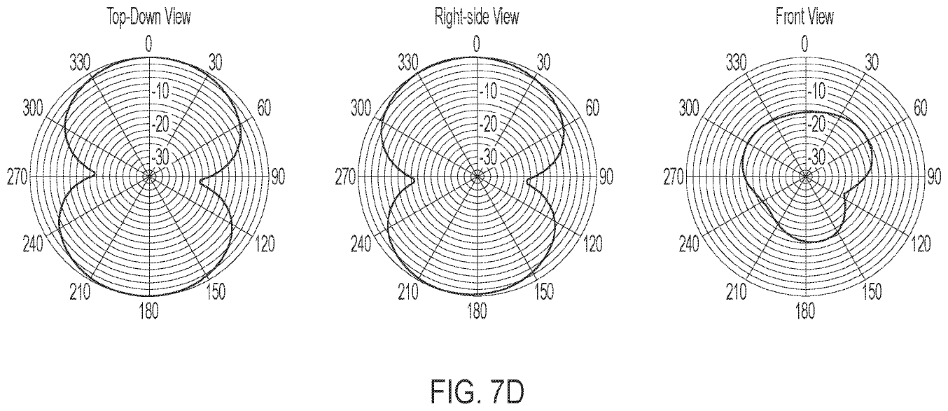

FIG. 7 illustrates an exemplary flow chart for a process 700 of operating an acoustic waveguide according to embodiments of this disclosure. In one or more examples, steps shown in process 700 can be, optionally, combined, modified, and/or omitted. While portions of process 700 may be described with respect to one or more components of acoustic waveguide 600A, a skilled artisan will understand that the process 700 can apply to one or more of the acoustic waveguides disclosed herein.

At step 702, the sound source of the acoustic waveguide, e.g., sound source 602A, can emit at a first end of the acoustic waveguide 600A one or more acoustic waves, e.g., acoustic waves 624, corresponding to an audio signal. In one or more examples, the audio signal can correspond to one or more sounds associated with the XR environment. In some embodiments, an audio signal can be continually generated and/or output while a user is using a XR system (e.g., XR system 200). In some embodiments, the audio signal can be received from an audio spatializer, e.g., DSP audio spatializer 422. In some examples, the one or more acoustic waves 624 can propagate in a longitudinal direction along a length of the waveguide 604A. In one or more examples, the diameter and/or cross-section of the waveguide 604A can be tuned such that audible frequencies propagate in a longitudinal direction. In some embodiments, the one or more acoustic waves can range from the frequency of 50 Hz-5000 Hz.

At step 704, the acoustic waveguide can receive, at a first acoustic vent, one or more acoustic waves. For example, the acoustic waveguide 600A can receive at a first acoustic vent 608a, one or more acoustic waves at a first time. At step 706, the acoustic waveguide can generate a first sound source, where the first sound source is radiated from the first acoustic vent. For example, the acoustic waveguide 600A can generate a first sound source 626a, where the first sound source 626a is radiated from the first acoustic vent 608a. In one or more examples, a distance between the sound source 606A and first acoustic vent 608a can be tuned such that undesirable frequencies, e.g., evanescent waves at lower frequencies, are not included in the first sound source.

At step 708, the acoustic waveguide can receive, at a second acoustic vent, one or more acoustic waves (e.g., after the one or more acoustic waves are received at the first acoustic vent). For example, the acoustic waveguide 600A can receive at a second acoustic vent 608b, one or more acoustic waves at a second time. At step 710, the acoustic waveguide can generate a second sound source, where the second sound source is radiated from the second acoustic vent. For example, the acoustic waveguide 600A can generate a second sound source 626b, where the second sound source 626b is radiated from the second acoustic vent 608b. In one or more examples, a distance between the first acoustic vent 608a, the second acoustic vent 608b, and/or diameter of the waveguide 604a can be tuned such that the difference between the first time and the second time corresponds to the amount of time it takes for the one or more acoustic waves 624 to travel between the first acoustic vent 608a and the second acoustic vent 608b.

At step 712 the acoustic waveguide can present the first sound source and the second sound source. For example, as shown in the figure, the acoustic waveguide 600A can present at least the first sound source 626a and second sound source 626b to an ear 630 of a user. For example, the user may be wearing a head wearable device that includes the acoustic waveguide 600A. In one or more examples, the first sound source 626a and second sound source 626b can form an acoustic wavefront 628 that can be received as a frontal wavefront at the ear 630 of the user. In this manner, the first sound source 626a and second sound source 626b can provide frontal sound incidence on the user's ear, such that the acoustic signature of the user's pinna is included in the sound heard by the user. In this manner, embodiments of the present disclosure can change the velocity of the wave with acoustic mesh of various weave geometry, diameter of weave and materials the invention will allow the phase to be altered to a focused wave front radiating to the user's ear. This focused acoustical wave can improve efficiency of the process, and reduce leakage of the energy away from the ear.

In one or more embodiments, the one or more acoustic waves 624 can be absorbed by the sound absorber 606A positioned at a second end of the waveguide 604A. In this manner, the resonance of the one or more acoustic waves 624 within the waveguide 604A can be reduced.

FIG. 7B illustrates exemplary audio radiation patterns that illustrate the propagation of sound from an acoustic waveguide according to embodiments of the present disclosure. The audio radiation patterns illustrate how sound from the acoustic waveguide can travel through space. The alignment of the vent orientation can determine the angle of propagation of the acoustic wave and/or the polar directivity. In some embodiments, mesh impedance can also influence the phase alignment of the propagation of the acoustic wave. As shown in the figure, sound emanating from an acoustic waveguide can propagate in a bi-pole directive polar pattern 728. As shown in the figure, the sound is directed in a direction m toward a user's ear 730 and in a direction n opposite direction m, where sound propagated in direction m may have a greater amplitude than sound propagated in direction n. As shown in the figure, direction m may be oriented downward from a lower surface of the acoustic waveguide and toward the head and/or ear of a user, while direction n may be oriented in an upward direction away from a user's ear 730.

FIG. 7C illustrates exemplary audio radiation patterns that illustrate the propagation of sound from an acoustic waveguide according to embodiments of the present disclosure. The audio radiation patterns illustrate how sound from the acoustic waveguide can travel through space. As shown in the figure, sound emanating from an acoustic waveguide can propagate in a bi-pole directive polar pattern 728. As shown in the figure, the sound is directed in a direction m toward a user's ear 730 and in a direction n opposite direction m. Similar to FIG. 7B, direction m may be oriented downward from a lower surface of the acoustic waveguide and toward the head and/or ear of a user, while direction n may be oriented in an upward direction away from a user's ear 730, where sound propagated in direction m may have a greater amplitude than sound propagated in direction n. In some examples, the directive polar pattern can correspond to other shapes, for example, but not limited to, cardioid, hyper-cardioid, and irregular shapes for specific applications.

FIG. 7D illustrates exemplary audio radiation patterns that illustrate the amplitude of sound in different directions. For example, FIG. 7D can correspond to cross-sectional views of FIG. 7C. As shown in the figure, sound propagated by the acoustic waveguide has the greatest amplitude in a forward and rearward direction, where 0° corresponds to direction m, e.g., toward the ear and 180° corresponds to direction m, e.g., away from the ear. The amplitude is smallest in a lateral direction, e.g., 900 and 270°, from the acoustic waveguide. In this manner, acoustic waveguides in accordance with embodiments of the present disclosure can reduce audio leakage in a lateral direction away from a head of the user.

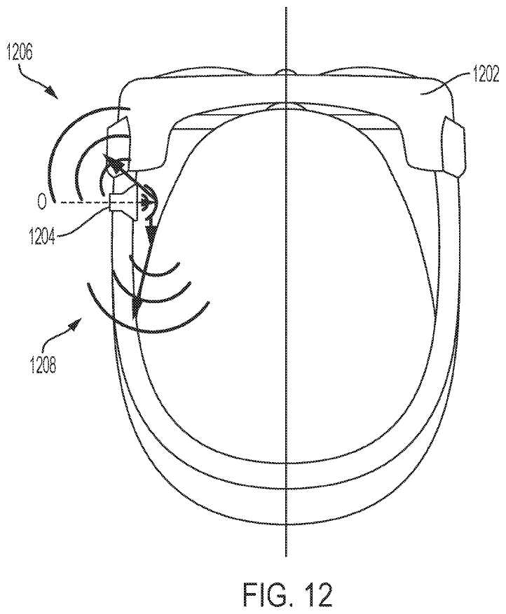

For example, referring briefly to FIG. 12, an exemplary wearable head device 1202 with speaker 1204 is shown. As shown in the figure, the speaker 1204 may be located in an arm of the wearable head device and directed toward a head of the user. The speaker can emit an acoustic wave in a direction O toward a temple of the user. The acoustic wave can reflect off the users temple such that a first portion of the reflected acoustic wave 1208 travels toward an ear of the user, while a second portion of the acoustic wave 1206 travels laterally, e.g., propagates to a user's environment. Such audio leakage can lead to privacy concerns for a user and/or be an annoyance to individuals in a user's environment who can hear sound from the speaker 1204.

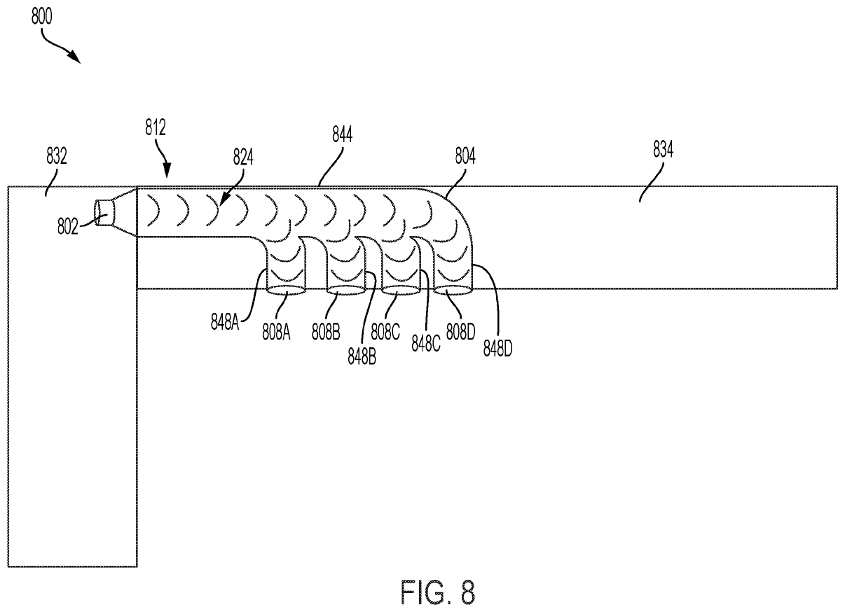

FIG. 8 illustrates an acoustic waveguide 800 disposed in a wearable head device, according to embodiments of this disclosure. As shown in the figure, the acoustic waveguide 800 can include a sound source 802, a waveguide manifold 804, and one or more acoustic vents 808a-808d. In some embodiments, the acoustic vents 808a-808d can include acoustic mesh as described above with respect to acoustic vents 528a-528d. As shown in the figure, the sound source 802 can be disposed on the front frame 832 of the wearable head device. In this manner, the weight of the sound source can be distributed to the bridge of the nose, allowing for a more comfortable weight distribution for the user. Additionally, this can enable the temple portion 834 to be thinner and lighter than a temple portion that supports a sound source, e.g., right temple arm 2132 that supports right speaker 2136. In some examples, the sound source 802 can be disposed on the temple portion 834.

In some examples, the waveguide manifold 804 can be disposed in the temple portion 834, e.g., the arm, of a head wearable device. As shown in the figure, the waveguide 804 can correspond to an acoustic manifold. In one or more examples, the waveguide manifold 804 can include an inlet 812 at a first end of the waveguide manifold 804, a manifold body 844, one or more branches 848a-848d, each branch corresponding to an acoustic vent 808a-808d. As shown in the figure, the waveguide manifold 804 can receive one or more sound waves 824 produced by a sound source 802. The one or more sound waves 824 can propagate in a longitudinal direction in the body 844 of the waveguide manifold 804. As the one or more sound waves 824 approach the one or more branches 848a-848d, the one or more sound waves can propagate in each of the corresponding branches 848a-848d and exit the waveguide manifold 804 via the respective acoustic vents 808a-808d. In one or more examples, the acoustic waveguide 800 can be operated according to process 700.

In some embodiments, the distance between the inlet 812 and each acoustic vent 808a-808d can determine the timing of the one or more sound waves that radiate from a particular acoustic vent. In some examples, the distance between the inlet 812 and the each acoustic vent 808a-808d can be tuned such that the time delay between one or more sound waves exiting between adjacent vents, e.g., the first acoustic vent 808a and second acoustic vent 808b, corresponds to the difference between the amount of time it takes for the one or more acoustic waves 624 to travel between the inlet and each of the adjacent vents, e.g., the time difference between a first time it takes the one or more acoustic waves to travel between the inlet 812 and the first acoustic vent 808a and a second time it takes the one or more acoustic waves to travel between the inlet 812 and the second acoustic vent 808b.

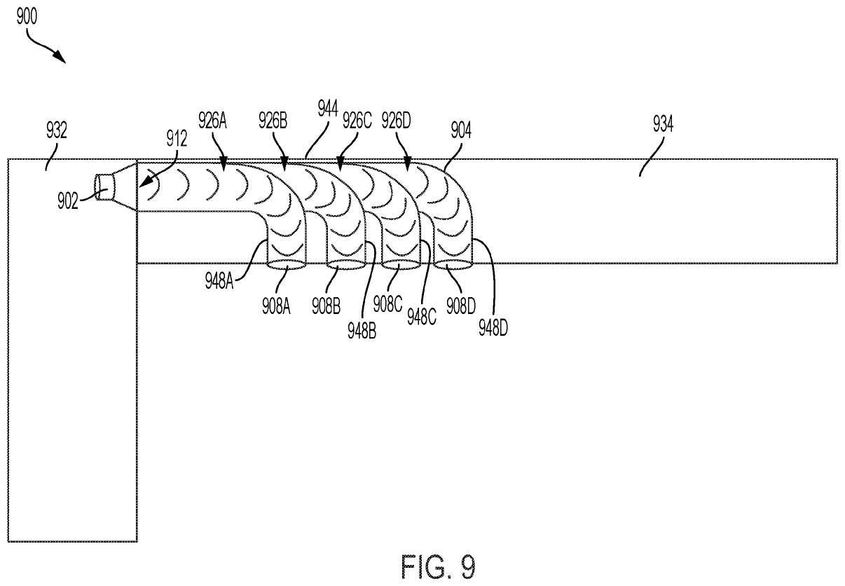

FIG. 9 illustrates an acoustic waveguide 900 disposed in a wearable head device, according to embodiments of this disclosure. As shown in the figure, the acoustic waveguide 900 can include a sound source 902, a waveguide manifold 904, and one or more acoustic vents 908a-908d. In some embodiments, the acoustic vents 808a-808d can include acoustic mesh as described above with respect to acoustic vents 528a-528d. As shown in the figure, the sound source 902 can be disposed on the front frame 932 of the wearable head device. In this manner, the weight of the sound source can be distributed to the bridge of the nose, allowing for a more comfortable weight distribution for the user. Additionally, this can enable the temple portion 934 to be thinner and lighter than a temple portion that supports a sound source, e.g., right temple arm 2132 that supports right speaker 2136. In some examples, the sound source 902 can be disposed on the temple portion 834. In one or more examples, the acoustic waveguide 900 can be operated according to process 700.

In some examples, the waveguide manifold 904 can be disposed in the temple portion 934, e.g., the arm, of a head wearable device. As shown in the figure, the waveguide manifold 904 can correspond to an acoustic manifold. In one or more examples, the waveguide manifold 904 can include an inlet 912, and one or more manifold branches 948a-948d, each branch corresponding to an acoustic vent 908a-908d. As shown in the figure, the waveguide manifold 904 can receive one or more sound waves 926a-926d from a sound source 902a via the inlet 912. As shown in the figure, each branch 948a-948d can connect the inlet 912 to a respective acoustic vent 908a-908d. In such embodiments, the one or more sound waves 926a-926d produced by the sound source 902 may have a separate, non-overlapping path, where each path can correspond to one of the manifold branches 948a-948d that lead to a respective acoustic vent 908a-908d. For example, sound waves can be received via the inlet 912 of waveguide manifold 904 and travel as sound waves 926a through the branch 948a to the acoustic vent 908a. Similarly, sound waves 926b can travel from the inlet 912, through the branch 948b to the acoustic vent 908b without substantial overlap with the path of sound waves 926a in branch 848a. In such embodiments, where there is minimal overlap between the branches, e.g., branches 948a-948d, there may be better control of the acoustic propagation because there is no shared acoustic path for each of the one or more sound waves 926a-926d that travel through the waveguide manifold 904, e.g., via a respective branch 948a-948d.

In some embodiments, the distance between the inlet 912 and each acoustic vent 908a-908d can determine the timing of the one or more sound waves 926a-926d that radiate from a particular acoustic vent. In some examples, the distance between the inlet 912 and the each acoustic vent 908a-908d can be tuned such that the time delay between one or more sound waves exiting between adjacent vents, e.g., the first acoustic vent 908a and second acoustic vent 908b, corresponds to the difference between a first time it takes a first acoustic waves 926a to travel from the inlet to the first vent 908a and the time it takes a second acoustic wave 926b to travel from the inlet 912 to the second vent 908b.

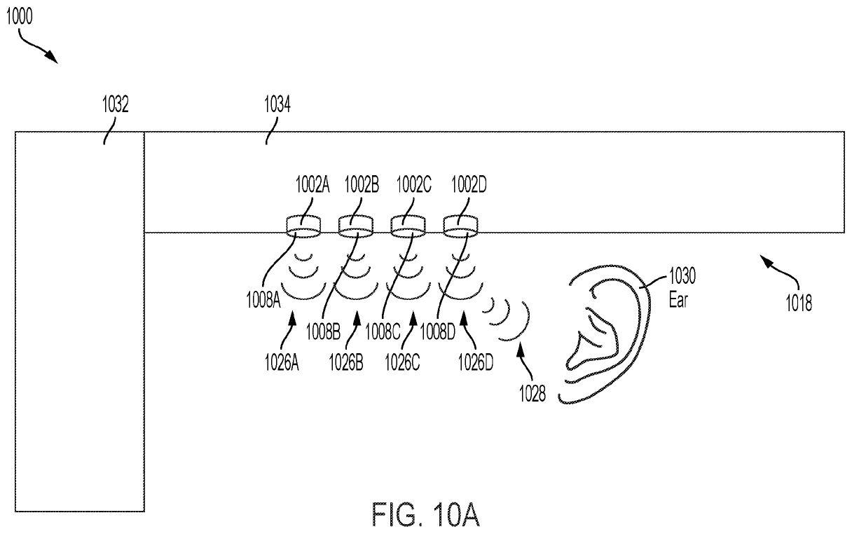

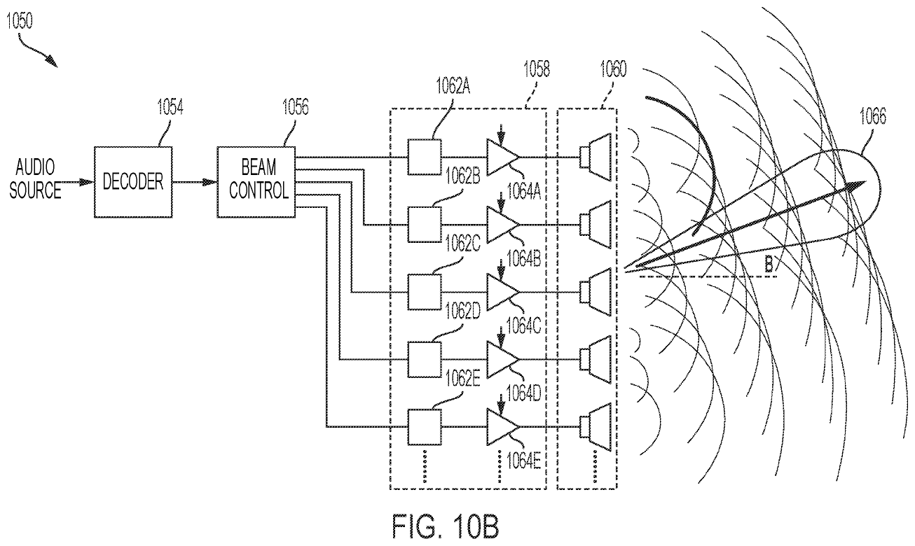

FIG. 10A illustrates a sound system 1000 disposed in a wearable head device, according to embodiments of this disclosure. As shown in the figure, the sound system 1000 can include a transducer array 1002 that includes a plurality of transducers 1002a-1002d. While four transducers are shown in the figure, a skilled artisan will know that the transducer array can include any number of transducers without departing from the scope of this disclosure. In some embodiments, the transducers can be disposed on a lower surface 1018 of a temple portion 1034 of a wearable head device. In one or more examples, the lower surface 1018 can include a plurality of apertures 1008a-1008d, such that each transducer 1002a-1002d is positioned in or near a respective aperture. For example, first transducer 1002a can be disposed in first aperture 1008a, second transducer 1002b can be disposed in second aperture 1008b, etc. Each of the transducers 1002a-1002d can be configured to receive an audio signal and generate one or more acoustic waves based on the audio signal.

FIG. 10B illustrates a sound system 1050, according to embodiments of the present disclosure. As shown in the figure, the sound system 1050 can include an audio source, a decoder 1054, a DSP 1056, a phase delay amplification 1058, and a speaker array 1060. The phase delay amplification can include a phase delay 1062A-1062E and an amplification 1064A-1064E, where each phase delay and corresponding amplification is associated with a transducer or speaker in the speaker array 1060. In some embodiments, each transducer can have a discrete signal path from a digital signal processing system (DSP) to a discrete amplifier. In some embodiments, each transducer can be phase correlated to an algorithm from the DSP to radiate a beamforming (focused) pattern 1060, e.g., such that the beamforming pattern is directed toward the ear of the wearer.

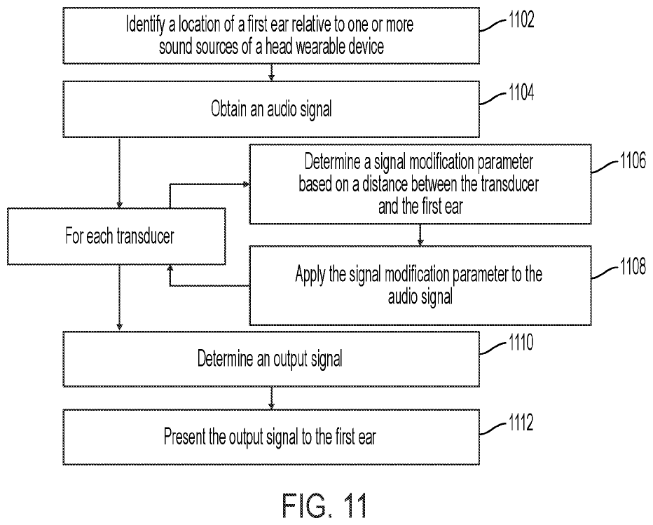

FIG. 11 illustrates block diagram of a process 1100 for operating a sound system according to embodiments of this disclosure. In one or more examples, the process 1100 can correspond to a sound system as shown in FIG. 10. At step 1102, the system can identify a location of a first ear relative to one or more sound sources of a head wearable device. For example, the system can determine a distance between the one or more sound sources and the first ear. In some examples, the one or more sound sources can correspond to the transducer array 1002 of sound system 1000. In some embodiments, identifying the location of the first ear can correspond to identifying an expected position of the ear with respect to the one or more sound sources. At step 1104, the system can obtain an audio signal. In one or more examples, the audio signal can correspond to one or more sounds associated with the XR environment. In some embodiments, an audio signal can be continually generated and/or output while a user is using a XR system (e.g., XR system 200).

For each transducer at step 1106, the system can determine a signal modification parameter based on a distance between the transducer and the first ear. In some examples, the signal modification parameter can correspond to a time delay. At step 1108, for each transducer, the signal modification can be applied to the audio signal for the corresponding transducer. For example, a first transducer 1002a may have a first time delay introduced to a first signal corresponding to the first transducer 1002a, while the second transducer 1002b may have a second time delay introduced to a second signal corresponding to the second transducer 1002b, where the first and second time delay are different. In this manner, providing separate transducers can allow the sound system, e.g., sound system 1000, to have more control over the fine-tuning of the delay and other signal processing applied to the audio signal set to each transducer.

At step 1110 an output signal can be determined based on the modified audio signal for each transducer, e.g., transducers 1002a-1002d. At step 1112, the output signal can be presented to a first ear 1030 of a user. For example, the output audio signal 1028 presented to a first ear 1030 of a user can correspond to the individual outputs 1026a-1026d of each of the transducers 1002a-1002d. In this manner, the output signal can be presented as an audio source having a frontal wavefront relative to the user's ear. Accordingly, the sound heard by the user naturally includes the user's acoustic pinna signature.

Embodiments of the present disclosure are directed to an acoustic waveguide for presenting an audio signal and methods of use. An apparatus in accordance with embodiments of this disclosure can include a waveguide member comprising a hollow body having a first end and a second end. The apparatus can further include a sound source disposed at the first end of the waveguide member configured to emit at least a first sound wave. The apparatus can further include a plurality of acoustic vents disposed on a lower surface of the body of the waveguide member, wherein each of the plurality of acoustic vents is configured to receive the first sound wave and further configured to emit a respective sound wave based on the first sound wave, wherein each respective sound wave corresponds to a respective point sound source.

In some embodiments, the apparatus can further include a sound absorber disposed at the second end of the waveguide member. In some embodiments, each of the plurality of acoustic vents corresponds to a respective point sound source. In some embodiments, the apparatus is configured such that a first respective sound wave emitted from the first plurality of acoustic vents comprises audio frequencies within a predetermined range and is further configured to filter audio frequencies below the predetermined range. The predetermined range can comprise one or more of 50 Hz to 150 Hz, 50 Hz to 250 Hz, 200 Hz to 500 Hz, and 400 Hz to 1 kHz. In some embodiments, the waveguide member is configured to propagate the first sound wave as a longitudinal wave. In some embodiments, the body of the waveguide member can include a plurality of branches, each branch of the plurality of branches corresponding to one of the plurality of acoustic vents. In such embodiments, each branch of the plurality of branches can comprise a unique path between the first end of the waveguide member and the corresponding acoustic vent.

An apparatus in accordance with embodiments of the present disclosure can include acoustic mesh disposed across a corresponding opening of the one or more of the plurality of acoustic vents. In some embodiments, the acoustic mesh can comprise at least one selected from a Dutch Twill weave pattern, a Dutch Plain Weave pattern, a Reverse Plain Dutch Weave, and a Multiplex Twilled Weave. In some embodiments, the acoustic mesh can comprise a material having at least one of a monofilament material property, a polyester property, a polyimide property, a polypropylene property, a polyamide property, a nylon material, and a meta-aramid property.

In some embodiments, the plurality of acoustic vents can be located on at least one of a temple-side or a lower surface of the waveguide member. In some embodiments, the plurality of acoustic vents are arranged to propagate an acoustic wave, the acoustic wave comprising each of the respective sound waves and the acoustic wave having at least one of a predetermined propagation direction and a predetermined polar directivity pattern. In such embodiments, the predetermined polar directivity pattern can comprise at least one selected from a cardioid pattern, hyper-cardioid pattern, and an irregular pattern.

Embodiments of the present disclosure can include a head wearable device. For example, the head wearable device can include a front frame, a display coupled to the front frame, an arm coupled to the front frame and configured to attach the head wearable device to a user's head, and an acoustic waveguide. In one or more examples, the acoustic waveguide can include a waveguide member comprising a hollow body having a first end and a second end, a sound source disposed at the first end of the waveguide, and a plurality of acoustic vents disposed on a lower surface of the body of the waveguide, wherein each of the plurality of acoustic vents is configured to receive the first sound wave and further to emit a respective sound wave based on the first sound wave, wherein each respective sound wave corresponds to a respective point sound source.

In some examples, the waveguide member can be disposed in the arm. In some examples, the sound source can be disposed in the front frame.

In some examples, the acoustic waveguide can further include a sound absorber disposed at the second end of the waveguide member. In some examples, each of the plurality of acoustic vents can correspond to a respective point sound source. In some examples, the acoustic waveguide is configured such that a first respective sound wave emitted from the first plurality of acoustic vents comprises audio frequencies within a predetermined range and is further configured to filter audio frequencies below the predetermined range. The predetermined range can comprise one or more of 50 Hz to 150 Hz, 50 Hz to 250 Hz, 200 Hz to 500 Hz, and 400 Hz to 1 kHz. In some examples, the waveguide member is configured to propagate the first sound wave as a longitudinal wave. In some examples, the body of the waveguide member comprises a plurality of branches, each branch of the plurality of branches corresponding to one of the plurality of acoustic vents. In such examples, each branch of the plurality of branches comprises a unique path between the first end of the waveguide member and the corresponding acoustic vent.

A head wearable device in accordance with embodiments of the present disclosure can include acoustic mesh disposed across a corresponding opening of the one or more of the plurality of acoustic vents. In some embodiments, the acoustic mesh can comprise at least one selected from a Dutch Twill weave pattern, a Dutch Plain Weave pattern, a Reverse Plain Dutch Weave, and a Multiplex Twilled Weave. In some embodiments, the acoustic mesh can comprise a material having at least one of a monofilament material property, a polyester property, a polyimide property, a polypropylene property, a polyamide property, a nylon material, and a meta-aramid property.

In some embodiments, the plurality of acoustic vents can be located on at least one of a temple-side or a lower surface of the waveguide member. In some embodiments, the plurality of acoustic vents are arranged to propagate an acoustic wave, the acoustic wave comprising each of the respective sound waves and the acoustic wave having at least one of a predetermined propagation direction and a predetermined polar directivity pattern. In such embodiments, the predetermined polar directivity pattern can comprise at least one selected from a cardioid pattern, hyper-cardioid pattern, and an irregular pattern.

Embodiments of the present disclosure can include methods for presenting audio signals. According to one or more embodiments, the methods can include: emitting, via a sound source, one or more acoustic waves of an audio signal into a waveguide member of an acoustic waveguide, receiving, at a first acoustic vent, the one or more acoustic waves, wherein the first acoustic vent is disposed on a lower surface of the waveguide member, generating a first point sound source at the first acoustic vent based on the one or more acoustic waves, receiving, at a second acoustic vent, the one or more acoustic waves, wherein the second acoustic vent is disposed on the lower surface of the waveguide member, generating a second point sound source at the second acoustic vent based on the one or more acoustic waves, and presenting a first audio signal corresponding to the first point sound source, and presenting a second audio signal corresponding to the second point sound source.

In some examples, the methods can further include absorbing, via a sound absorber, the one or more acoustic waves at a second end of the acoustic waveguide, wherein the second end is opposite the sound source disposed at a first end of the acoustic waveguide. In some examples, presenting the first sound source comprises presenting a frontal wavefront to an ear of a user; and presenting the second sound source comprises presenting the frontal wave to the ear of the user. In some examples, a body of the waveguide member comprises a plurality of branches, each branch of the plurality of branches corresponding to one of the plurality of acoustic vents.

Although the disclosed examples have been fully described with reference to the accompanying drawings, it is to be noted that various changes and modifications will become apparent to those skilled in the art. For example, elements and/or components illustrated in the drawings may be not be to scale and/or may be emphasized for explanatory purposes. As another example, elements of one or more implementations may be combined, deleted, modified, or supplemented to form further implementations. Other combinations and modifications are to be understood as being included within the scope of the disclosed examples as defined by the appended claims.

1. An apparatus comprising:
a waveguide member comprising a hollow body having a first end and a second end;
a sound source disposed at the first end of the waveguide member configured to emit at least a first sound wave; and
a plurality of acoustic vents disposed on a body of the waveguide member, wherein each of the plurality of acoustic vents is configured to receive the first sound wave and further configured to emit a respective sound wave based on the first sound wave, wherein each respective sound wave corresponds to a respective point sound source.

2. The apparatus of claim 1, further comprising a sound absorber disposed at the second end of the waveguide member.

3. The apparatus of claim 1, wherein each of the plurality of acoustic vents corresponds to a respective point sound source.

4. The apparatus of claim 1, wherein the apparatus is configured such that a first respective sound wave emitted from a first plurality of acoustic vents comprises audio frequencies within a predetermined range and is further configured to filter audio frequencies below the predetermined range.

5. The apparatus of claim 4, wherein the predetermined range comprises one or more of 50 Hz to 150 Hz, 50 Hz to 250 Hz, 200 Hz to 500 Hz, and 400 Hz to 1 kHz.

6. The apparatus of claim 1, wherein the waveguide member is configured to propagate the first sound wave as a longitudinal wave.

7. The apparatus of claim 1, wherein the body of the waveguide member comprises a plurality of branches, each branch of the plurality of branches corresponding to one of the plurality of acoustic vents.

8. The apparatus of claim 7, wherein each branch of the plurality of branches comprises a unique path between the first end of the waveguide member and the corresponding acoustic vent.

9. The apparatus of claim 1, wherein one or more of the plurality of acoustic vents includes an acoustic mesh disposed across a corresponding opening of the one or more of the plurality of acoustic vents.

10. The apparatus of claim 9, wherein the acoustic mesh comprises at least one selected from a Dutch Twill weave pattern, a Dutch Plain Weave pattern, a Reverse Plain Dutch Weave, and a Multiplex Twilled Weave.

11. The apparatus of claim 9, wherein the acoustic mesh comprises a material having at least one of a monofilament material property, a polyester property, a polyimide property, a polypropylene property, a polyamide property, a nylon material, and a meta-aramid property.

12. The apparatus of claim 1, wherein the plurality of acoustic vents is located on at least one of a temple portion of the waveguide member and a lower surface of the waveguide member.

13. The apparatus of claim 1, wherein the plurality of acoustic vents is arranged to propagate an acoustic wave, the acoustic wave comprising each of the respective sound waves and the acoustic wave having at least one of a predetermined propagation direction and a predetermined polar directivity pattern.

14. The apparatus of claim 13, wherein the predetermined polar directivity pattern comprises at least one of a cardioid pattern, a hyper-cardioid pattern, and an irregular pattern.

15. A head wearable device comprising:
a front frame;
a display coupled to the front frame;
an arm coupled to the front frame and configured to attach the head wearable device to a user's head; and
an acoustic waveguide comprising:
a waveguide member comprising a hollow body having a first end and a second end,
a sound source disposed at the first end of the waveguide, and
a plurality of acoustic vents disposed on a body of the waveguide, wherein each of the plurality of acoustic vents is configured to receive the first sound wave and further to emit a respective sound wave based on the first sound wave, wherein each respective sound wave corresponds to a respective point sound source.

16. The head wearable device of claim 15, wherein the waveguide member is disposed in the arm.

17. The head wearable device of claim 15, wherein the sound source is disposed in the front frame.

18.-29. (canceled)

30. A head wearable device comprising:
a front frame;
a display coupled to the front frame;
an arm coupled to the front frame and configured to attach the head wearable device to a user's head; and
an acoustic waveguide comprising:
an audio source;
a decoder coupled to the audio source and configured to produce an audio signal;
a digital signal processor (DSP) configured to receive the audio signal from the decoder and generate a beamformed signal;
a plurality of acoustic vents disposed on a lower surface of the acoustic waveguide; and
a plurality of audio transducers, each audio transducer disposed in a respective acoustic vent of the plurality of acoustic vents, wherein each audio transducer is configured to receive a discrete output signal that has been phase correlated to produce a directive audio wave.

31. A method for presenting audio signals comprising:
emitting, via a sound source, one or more acoustic waves of an audio signal into a waveguide member of an acoustic waveguide;
receiving, at a first acoustic vent, the one or more acoustic waves, wherein the first acoustic vent is disposed on a lower surface of the waveguide member;
generating a first point sound source at the first acoustic vent based on the one or more acoustic waves;
receiving, at a second acoustic vent, the one or more acoustic waves, wherein the second acoustic vent is disposed on the lower surface of the waveguide member;
generating a second point sound source at the second acoustic vent based on the one or more acoustic waves; and
presenting a first audio signal corresponding to the first point sound source; and
presenting a second audio signal corresponding to the second point sound source.

32. The method of claim 32, comprising absorbing, via a sound absorber, the one or more acoustic waves at a second end of the acoustic waveguide, wherein the second end is opposite a first end of the acoustic waveguide.

33.-35. (canceled)
